(19) United States
(12) Patent Application Publication
(10) Pub. No.: US 2026/0324899 A1
(43) Pub. Date: Oct. 22, 2026

(54) IMPROVED CENTRIFUGAL COFFEE BREWER

(71) Applicant: SPINN HOLDING B.V., Amsterdam (NL)

(72) Inventors: Serge Alfred Johan DE WARRIMONT, Amsterdam (NL); Nicholas Alexander EVANS, Amsterdam (NL); Lucas Matthias STEITNER, Vianen (NL)

(21) Appl. No.: 19/486,647

(22) PCT Filed: May 23, 2024
(86) PCT No.: PCT/EP2024/064285

§ 371 Date: Nov. 21, 2025

(30) Foreign Application Priority Data
May 23, 2023 (NL) 2034898

(51) Int. Cl. A47J 31/22; A47J 31/42; A47J 31/60

(52) U.S. Cl. CPC A47J 31/22; A47J 31/42; A47J 31/60

(57) ABSTRACT

In an aspect, the invention relates to a centrifugal coffee brewing device, the centrifugal coffee brewing device comprising:—a spinning assembly which is rotatable about a main axis for centrifuging coffee, the spinning assembly comprising a brewing chamber,—a coffee bean grinder comprising a first burr and a second burr, wherein the first and second burr are rotatable relative to one another about a grinder axis, wherein the main axis and the grinder axis are coaxial.

### FIELD OF THE INVENTION

The present invention relates to a centrifugal coffee brewer. Centrifugal coffee brewers are known.

### BACKGROUND OF THE INVENTION

State-of-the-art coffee brewing machines for an average household kitchen either require expensive single serve capsules or are relatively large to fit on the countertop. Bean-to-cup coffee machines generally produce fine cups of coffee without plastic residual waste of the single serve capsules. However, these bean-to-cup machines are relatively expensive and large for most purposes. A coffee brewing device that uses centrifugal force to extract liquid coffee from a coffee residue might be able overcome these challenges. A number of centrifugal coffee brewing devices have been developed, but there is still a demand for a more user-friendly, silent and cost efficient solution.

An example of such a centrifugal coffee brewer is disclosed in WO2019/031964A1 (herein: D1). The coffee brewer of D1 comprises a brewing chamber 26, a main drive 27, a coffee bean grinder 120 and a hot fluid supply 58. The coffee bean grinder produces coffee ground from coffee beans. The coffee ground is moved to the brewing chamber by a supply tube 92 with a transport screw 95. Coffee ground is mixed with hot water in the brewing chamber. The brewing chamber is rotatable about a main axis by the main drive. The spinning brewing chamber creates a centrifugal force to filter liquid coffee from a coffee residue which can be supplied to the user of the device. In the present invention it was recognized that this device has a number of drawbacks.

One drawback is that the device is relatively tall for a coffee brewing machine. This is mainly caused by the position of some components with respect to the brewing chamber. For example, the coffee bean grinder occupies a certain space above the brewing chamber and requires two separate drives. More or less the same is true for the hot water supply, which also occupies a certain space next to the brewing chamber. Overall, the device is relatively large and in particular relatively tall for an average household kitchen. Another problem of the device is that the coffee brewer of D1 produces a relatively high level of noise during the production of coffee ground from coffee beans and the brewing process.

It was further recognized in the present invention that it is difficult to clean the filter using a flexible resin scraper 110 that engages the filter when it is moving upwards. Coffee residue may remain in and behind the filter. This might contaminate the next, possibly different, cup of coffee, which could disadvantageously affect the quality of the product. Buildup of coffee residue behind the filter causes unbalance in the filter frame, causing undesired vibrations and noise. In addition, the filter can get clogged, resulting in extra manual cleaning steps. Another drawback of the device disclosed in D1 is that the coffee collecting chamber requires an additional heater 470 to ensure that the brewed coffee leaves the device with the right temperature.

Another example of a centrifugal coffee brewer is disclosed in WO2017/204472A1 (herein: D2). The centrifugal coffee brewer comprises a hot water inlet 41, a ground coffee inlet 42, a mixing chamber 50, and a coffee collecting chamber 80. The mixing chamber is rotatable about a central axis by a direct drive assembly. The direct drive assembly comprises a direct drive electromotor having a stator 20 with coils 22, each coil having a main axis which extends radially and a rotor with permanent magnets 25. The rotor is positioned closer to the central axis than the stator. Hot water and ground coffee enter the mixing chamber through a inlet part 51, are distributed over the mixing chamber by a dispersing member 55 and subsequently moved outward by the centrifugal force of the rotating mixing chamber. Coffee is extracted from the ground coffee by a filter 60 before it is guided to the outlet by the coffee collecting chamber. Coffee residue in the mixing chamber is removed by rotation of the mixing chamber in a lower position.

The coffee brewer of D2 is also relatively tall when assembled as a complete centrifugal coffee brewer, i.e. with the required additional components such as a grinder, water heater, residue tray, water tank, etc.

U.S. Pat. No. 10,405,689B2 (herein: D3) discloses a coffee brewer designed to receive a single serve coffee capsule 60 and to pass a liquid through the coffee capsule using centrifugal forces. Hot water is supplied from above to the capsule that contains the coffee power. The single serve capsule has a conical shape that is wider at the upper part of the capsule. The capsule spins due to a driving unit with an electrical motor. This forces the coffee liquid upwardly along the conical walls of the capsule into a collecting part 24. Cold water from a liquid reservoir 7 is heated in a helicoidal heater 120 that is part of a collecting unit 18. Heat is supplied by a resistive heater 100.

A drawback of the device disclosed in D3 is that it lacks heating efficiency. The helicoidal duct and resistive heater are positioned almost completely below the single serve capsule, while hot water is supplied to the single serve capsule through the upper part of the device. An extensive flow path increases the losses of thermal energy. Further, the flow of water through the helicoidal duct starts in the upper winding 120a and moves downwardly to the lowest winding. The thermal energy transfer from the helicoidal duct to the collecting part is therefore reduced, because the temperature of the upper winding is colder due to the flow of cold water.

Another drawback of the device disclosed in D3 is the position of the driving unit. The electrical motor is positioned below the collecting unit and brewing unit 2. This adds the requirement of an additional, relatively thin and long shaft to the brewing chamber. The device of D3 also has a brewing chamber with a relatively small diameter. Noise produced by the brewing process is relatively large due to the relatively small diameter of the brewing chamber and a thin and long shaft. Brewing chambers with smaller diameter require a higher RPM to make espresso. More rotations result in more vibrations, and more vibrations produce relatively more noise. Increasing the diameter of the brewing chamber of D3 is challenging because of the use of plastic pods as the brewing chamber in D3. The pods will then also need to be enlarged and increasing the size of the pods will increase the environmental footprint of each cup of coffee. In addition, increasing the thickness of the thin and long shaft requires a bigger drive and a bigger drive increases the overall costs of the device.

It was further recognized in the present invention that the size of the brewer bearings of D3 are relatively small with respect to the RPM requirements of the device. Relatively small bearings reduce the stability of the brewing chamber and produce more noise.

### OBJECT OF THE INVENTION

It is an object of the invention to provide a device which suffers less from at least one of the drawbacks mentioned above.

It is an further object of the present invention to provide a centrifugal coffee brewer which is sufficiently small and silent for an average household kitchen.

### SUMMARY OF THE INVENTION

The centrifugal coffee brewing device as disclosed herein provides several independent improvements over the prior art.

### Drive Assembly

In a first aspect, the present invention relates to a centrifugal coffee brewing device comprising:
a spinning assembly which is rotatable about a main axis for centrifuging coffee, the spinning assembly comprising a brewing chamber,
a coffee bean grinder comprising a first burr and a second burr, wherein the first and second burr are rotatable relative to one another about a grinder axis,
   wherein the main axis and the grinder axis are coaxial.

The grinder axis being coaxial with the main axis has an advantage that it provides a central position for the coffee bean grinder in the centrifugal coffee brewing device. The coffee bean grinder is a noise producing element and a central position may reduce the noise sensed by a user.

In some embodiments, the device may comprise a drive assembly configured for rotating the spinning assembly about the main axis, wherein the drive assembly comprises a stator and a rotor configured to rotate about a rotor axis, wherein the rotor axis is coaxial with the main axis and the grinder axis.

In some embodiments, the second burr may be connected to the spinning assembly and may be driven by the drive assembly via the spinning assembly.

By having the grinder axis coaxial with the main axis and rotor axis, the spinning assembly and coffee bean grinder can be rotated simultaneously by a single drive assembly. This makes a separate coffee bean grinder drive redundant and simplifies the design of the centrifugal coffee brewing device.

In some embodiments, the spinning assembly may comprise:
a chamber element comprising a bottom wall and a roof portion,
a cylinder element,
   wherein the chamber element and the cylinder element form the brewing chamber, and wherein the second burr is connected to the chamber element and rotates with the chamber element.

In some embodiments, the spinning assembly may further comprise an axle which extends downward from the second burr and is connected to the roof portion of the chamber element, and is driven by the roof portion of the chamber element.

In some embodiments, the spinning assembly may further comprise at least one screw which extends downwards from the second burr to connect the second burr to the roof portion of the chamber element, and to drive the second burr by the roof portion of the chamber element.

In some embodiments, multiple coils may be positioned in a circular arrangement on the stator, and wherein at least one magnet may be positioned in a circular arrangement on the rotor.

In some embodiments, the rotor may be connected to the spinning assembly, and in particular to a roof portion of the chamber element.

The direct connection between the drive assembly and the spinning assembly advantageously allows heating of the brewing chamber without a separate heating element of procedure. Thermal energy produced by induction heating in the drive assembly may be transferred to the brewing chamber through the roof portion of the chamber element. Pre-heating of the brewing chamber using steam before brewing coffee is therefore not required. This may reduce the production time of a cup of coffee and the device uses less water. Using induction heating of the drive assembly also has the advantage that waste water from pre-heating does not fill the drip tray. As a result, the drip tray need to be emptied less frequently.

In some embodiments, the coffee bean grinder may be positioned directly above the spinning assembly. This is particularly useful because it allows a direct and coaxial connection between the spinning assembly and the coffee bean grinder. This direct connection makes an additional transmission system redundant and therefore simplifies the rotational control of the spinning assembly and coffee bean grinder.

In some embodiments, the coffee bean grinder may be positioned on the same horizontal level of the spinning assembly or directly below the spinning assembly. These configurations also allow a direct and coaxial connection between the spinning assembly and the coffee bean grinder.

In some embodiments, at least a part of the coffee bean grinder may be positioned at a same vertical level as the drive assembly.

In some embodiments, at least a part of the coffee bean grinder may be positioned below the drive assembly.

An advantage of the relative positions of the spinning assembly, drive assembly and the coffee bean grinder is that it reduces the overall size of the centrifugal coffee brewing device. The coffee bean grinder may fit within the circular arrangement of the drive assembly. Together they may have a similar width as the spinning assembly, which can be therefore positioned directly below the coffee bean grinder and drive assembly. A separate drive assembly or coffee bean grinder eccentrically from the main axis would increase the overall design of the device.

Another advantage of the relative positions of the spinning assembly, drive assembly and the coffee bean grinder is that the device requires less components and is therefore less complex and less expensive to produce. Less components also reduce the assembling time and the device require less maintenance and/or repair.

In some embodiments, the stator may be positioned within the rotor and the rotor extends around the stator, wherein in particular the coils are positioned within the at least one magnet.

In some embodiments, the rotor may be positioned within the stator and the stator extends around the stator, wherein in particular the at least one magnet is positioned within the coils.

In some embodiments, the stator may be positioned above the rotor and the rotor may be positioned below the stator, wherein in particular the coils are positioned above the at least one magnet.

In some embodiments, the rotor may be positioned above the stator and the stator may be positioned below the rotor, wherein in particular the at least one magnet is positioned above the coils.

In some embodiments, the second burr may be positioned within the first burr.

In some embodiments, the drive assembly may perform a further function of increasing the temperature of the coffee bean grinder to reduce or prevent condensation in the coffee bean grinder, wherein in particular the temperature of the coffee bean grinder may be increased using radiative and/or conductive heat transfer from the drive assembly.

Condensation in the coffee bean grinder might affect the quality of a cup of coffee, because a part of the coffee ground may stick in the coffee bean grinder and is therefore not used in the brewing process. It also makes it more challenging to keep the coffee bean grinder clean after each cup of coffee. On the other side, it is desirable to limit the increment in temperature of the coffee bean grinder to prevent losing to much aroma from the coffee beans in the coffee bean grinder. Increasing the temperature of the grinder is especially important after the coffee beans are processed into coffee ground.

In some embodiments, the coffee bean grinder may include an additional temperature management device, such as a ventilator to reduce the temperature of the first and second burr.

In some embodiments, the drive assembly may drive both the spinning assembly and the coffee bean grinder, and wherein the centrifugal coffee brewing device may not comprise a separate grinder drive for rotating the first and second burr relative to one another.

In some embodiments, the spinning assembly may comprise at least one brewer bearing which provides radial and axial support to the spinning assembly, the rotor of the drive assembly and the second burr, and wherein the stator extends around the brewer bearing.

In some embodiments, the spinning assembly may comprise at least one brewer bearing which provides radial and axial support to the spinning assembly, the rotor of the drive assembly and the second burr, and wherein the diameter of the bearings is smaller than the diameter of the coffee bean grinder.

In some embodiments, the chamber element and the cylinder element may be movable relative to each other in the axial direction, wherein in particular the chamber element may be fixed in the axial direction and the cylinder element may be movable in the axial direction.

In some embodiments, the first burr and the second burr are movable relative to each other in the axial direction, wherein in particular the second burr is fixed in the axial direction and the first burr is movable in the axial direction.

This is particularly useful to reduce wear and tear of coffee bean grinder. Moving the first burr in a vertical direction away from the second burr prevents friction at higher rotational speeds of the second burr. The second burr rotates together with the brewing chamber, and the brewing chamber requires higher rotational speeds for the brewing process than the second burr requires for grinding the coffee beans. A varying distance between those elements also allows grinding to different sized coffee ground particles for different coffee recipes. And finally, it also supports the cleaning function of the coffee bean grinder.

The invention further relates to a method of brewing coffee, the method comprising:
providing coffee beans to the coffee bean grinder of the centrifugal coffee brewing device according to any of the preceding claims,
spinning the spinning assembly with the drive assembly, thereby rotating the first and second burr relative to one another in order to grind the coffee beans,
supplying hot water in the brewing chamber,
spinning the spinning assembly with the drive assembly in order to brew coffee.

The method provides the same advantages as the device.

### Heater-Gutter Device

In another independent aspect, a centrifugal coffee brewing device comprises:
a spinning assembly which is rotatable about a main axis, the spinning assembly comprising a brewing chamber for brewing coffee,
a pump,
a heater-gutter device comprising a heater and a gutter, the heater-gutter device comprising:
   an annular device, the annular device defining a gutter wall which defines a gutter via which the brewed coffee which is expelled from the spinning assembly travels to a spout,
   a helicoidal duct located in the annular device and extending about the main axis, wherein the helicoidal duct comprises multiple windings located at different vertical levels, the helicoidal duct comprising an inlet and an outlet, wherein the inlet is connected to a lower winding and the outlet is connected to an upper winding,
   the heater comprising at least one electric heating element located within the annular device, and extending about the main axis, wherein the at least one heating element is configured for:
      1) heating the gutter wall for reducing temperature losses of the brewed coffee, and
      2) heating water which travels through the helicoidal duct prior to the water being introduced in the brewing chamber,
      wherein the pump is configured to circulate water through the internal helicoidal duct from the inlet to the outlet in an upwardly spiraling direction.

An advantage of the proposed heater-gutter device is that a single heating element may be sufficient to increase the temperature of both the gutter wall and the helicoidal duct. A separate heating device to fulfill any of both functions is therefore redundant. This allows a reduction in overall size of the centrifugal coffee brewing device.

Another advantage of the proposed heater-gutter device is that hot water flowing through the upper winding contributes to increasing the temperature of the impact wall of the expelled coffee residue after each serving. A heated impact wall reduces condensation and prevents buildup of coffee residue on the impact wall.

In some embodiments, the impact wall of the coffee ground is heated by the heater to prevent condensation and coffee ground build up on the surface of the impact wall.

In some embodiments, the heater may comprise at least two heating elements, namely a first heating element and a second heating element which are independently controllable, wherein the first heating element comprises a first heating winding and the second heating element comprises a second heating winding, wherein each heating element comprises a separate power supply.

In some embodiments, the first heating element may be connected to a first power supply having a range of 200-600 Watt and the second heating element may be connected to a second power supply of 700-2000 Watt.

In some embodiments, the first heating element may be located above the second heating element.

In some embodiments, the annular device may comprise at least two annular bodies, an upper annular body and a lower annular body, wherein the upper annular body may be positioned above the lower annular body.

In some embodiments, the upper annular body may define the gutter wall.

In some embodiments, the helicoidal duct may be located in the lower annular body.

In some embodiments, at least one heating element may be positioned directly below the gutter. This heating elements ensures that the complete gutter wall is heated and able to increase the temperature of the brewing coffee which is expelled from the brewing chamber. Heating of the brewed coffee starts directly when the expelled brewed coffee hits the gutter wall.

In some embodiments, the gutter wall may be made of a plastic material which is indirectly heated by the heating elements of the heater. Indirect heating may ensure that the temperature of the gutter wall does not exceed 80 degrees Celsius to prevent affecting the crema of a cup of coffee.

In some embodiments, an upper, downstream winding of the helicoidal duct may be positioned lower than the uppermost heating element and further away from the gutter than the uppermost heating element.

In some embodiments, the lower, upstream winding of the helicoidal duct may be positioned lower than the lowermost heating element.

In some embodiments, the helicoidal duct may comprise at least three windings, and more in particular four windings.

The proposed configuration of the heater-gutter device with the helicoidal duct and two heating elements improves the thermal performance of the system. The relative positions of both heating elements with the helicoidal duct and the gutter ensure that the flow of cold water through the first winding is unable to reduce the temperature of the gutter. Two controllable heating elements make it possible to optimize the brewing and serving temperatures separately from each other for different coffee recipes. The heater-gutter device further improves the thermal efficiency. A part of the excessive thermal energy for heating cold water in the helicoidal duct does not go to waste, but may be used to heat the gutter wall.

In some embodiments, the gutter slopes down to the spout. This guides the flow brewed coffee through the gutter to the spout to be supplied to the user.

This aspect further relates to a method of brewing coffee, the method comprising:
providing ground coffee in the centrifugal coffee brewing device according to any of claims 15-23,
circulating cold water through the helicoidal duct of the heater-gutter device with the pump and heating the water with the heater,
supplying the hot water in the brewing chamber,
spinning the spinning assembly in order to brew coffee,
   wherein the heater heats the relatively cold water in the helicoidal duct, the gutter, and the brewed coffee in the gutter, and
   wherein the cold water circulates through the helicoidal duct in an upwardly spiraling direction, providing hot water at the outlet of the helicoidal duct.

### Hot Water Supply Assembly

In one another independent aspect, a centrifugal coffee brewing device comprises:
a spinning assembly which is rotatable about a main axis, the spinning assembly comprising a brewing chamber, wherein the spinning assembly comprises a bottom wall having a central aperture,
a hot water supply assembly for supplying hot water into the brewing chamber, the hot water supply assembly comprising:
   a spraying element configured to spray the hot water into the brewing chamber, wherein the spraying element comprises at least one nozzle,
   a supply channel which is configured to supply hot water to the spraying element, the supply channel comprising a first section and a second section,
      wherein the first section extends below the brewing chamber, and wherein the second section extends in an upward direction from the first section and extends through the central aperture in the bottom wall of the spinning assembly.

The options for the path of the supply channel from the outlet of the helicoidal duct to the spraying element are limited due to the spinning design of the brewing chamber and the position of a coffee bean grinder on top of the brewing chamber. The path through the central aperture of the brewing chamber has the advantage that it can have a fixed position and that a minimal distance from the outlet of the helicoidal duct to the spraying element. A shorter distance between the outlet and the spraying element reduces the thermal losses of hot water.

Another advantage of the path through the central aperture is that a roof portion of the brewing chamber can be closed to prevent that a water overfill of the brewing chamber can cause damage to components which are positioned above the brewing chamber.

In some embodiments, the spinning assembly may comprise an upstanding wall portion which extends upward from the bottom wall and which defines the central aperture, wherein the hot water supply assembly may be configured to supply the hot water into the brewing chamber over the upstanding wall portion.

The upstanding wall portion prevents that water supplied to the brewing chamber leaves the brewing chamber through the central aperture when the centrifugal force of a spinning brewing chamber does not force the water outwards. It ensures that the only way out is through the cylinder element.

In some embodiments, the brewing chamber may have an annular shape.

In some embodiments, the nozzle may be configured to spray hot water over a horizontal distance, and wherein the spraying element in particular may comprise multiple nozzles, wherein the multiple nozzles may be positioned next to each other, and in particular at a horizontal distance from one another.

In some embodiments, the spraying element may comprise at least one nozzle, in particular multiple nozzles, wherein the multiple nozzles may be configured to spray hot water at different angles, allowing an evenly distributed supply of hot water onto a coffee bed in the brewing chamber.

An evenly distributed supply of hot water onto a coffee bed is important for the brewing process. The device needs to rely on the fact that amount of coffee ground and hot water supplied to the brewing chamber are balanced for the respective coffee recipe. An unevenly distributed supply of hot water might result in an incomplete extraction of coffee from the coffee ground, resulting in a potentially different taste for every cup.

In some embodiments, the spraying element may be positioned eccentrically from the main axis.

The eccentric position of the spraying element places it directly above the upstanding wall portion of the brewing chamber. This reduces the spraying distance of hot water and ensures that none of the hot water supply leaks into the central aperture.

In this aspect, the invention further relates to a method of brewing coffee, the method comprising:
providing ground coffee in the centrifugal coffee brewing device (10) according to any of claims 36-41,
providing hot water to the spraying element with the supply channel and spraying hot water into the brewing chamber,
spinning the spinning assembly in order to brew coffee.

The method provides the same advantages as the device.

In an embodiment of the method, hot water may be supplied into the brewing chamber over an upstanding wall portion.

### Simplified Filter Concept

In another independent aspect, a centrifugal coffee brewing device comprises a spinning assembly which is rotatable about a main axis, the spinning assembly comprising:
a chamber element comprising a bottom wall and a roof portion,
a cylinder element comprising a cylindrical wall,
   wherein the roof portion comprises a peripheral edge,
   wherein the chamber element and the cylinder element form a brewing chamber,
   wherein the cylinder element and the chamber element are movable relative to one another between:
a first, lower position of the cylinder element relative to the chamber element in which the cylinder element forms a circumference of the brewing chamber and in which the spinning assembly has a brewing configuration, and
a second, upper position of the cylinder element relative to the chamber element in which the circumference of the brewing chamber is open, and in which second position coffee residue can be ejected by spinning the chamber element,
   wherein the peripheral edge and the cylindrical wall define at least one aperture between them when the cylinder element is in the first, lower position,
   wherein a filtration gap is formed by the at least one aperture between the peripheral edge and the cylindrical wall, and
   wherein the filtration gap allows brewed coffee to flow upwards through the filtration gap during the spinning of the spinning assembly while keeping the coffee residue in the brewing chamber.

It was found that this construction is robust and reliable, cost efficient and reduces the chance of clogging, due to the self-cleaning effect by the vertical movement after every serving.

In some embodiments, the cylinder element may comprise a conical section which may increase in diameter in an upward direction, wherein the conical shape may force the brewed coffee to travel upwards along the inner surface of the cylinder element outside the brewing chamber during spinning of the spinning assembly.

In some embodiments, the size of the filtration gap and the rotational speed of the spinning assembly may determine the pressure in the brewing chamber, and wherein different brewing chamber pressures allow brewing of different coffee recipes.

In some embodiments, the cylinder element may not comprise holes which extend through the cylindrical wall from the inside to the outside.

Holes in the cylinder element are difficult to completely clean after each serving. Small parts of residue that stay behind in and/or around the holes may result in mixing of flavors from different coffee recipes. The holes also can get clogged and thereby reduce the filter area. In addition, it may require additional cleaning steps to clean the surface behind the holes to prevent residue build up on these surfaces. The build up of coffee residue on the surface behind the holes may result in an unbalanced brewer and may add undesirable vibrations during spinning of the spinning assembly.

In some embodiments, the spinning assembly may comprise an annular wiper seal which is connected to the roof portion, wherein the annular wiper seal may be configured to wipe coffee residue from the cylinder element when the cylinder element is moved from the first, lower position to the second, upper position.

In some embodiments, the cylindrical wall may extend above the roof portion when the cylinder element is in the first, lower position.

In some embodiments, the at least one aperture may be an annular aperture.

In some embodiments, the cylinder element may comprise a vertical section.

In some embodiments, the vertical section of the cylinder element may comprise:
a first, lower vertical section,
a second, upper vertical section,
   wherein the second, upper vertical section may be located inwardly from the lower, vertical section of the cylinder element, wherein the inwardly extending upper, vertical section and the peripheral edge may define the annular aperture.

In some embodiments, the distance between the cylinder wall and the peripheral edge of the roof portion may be 0-0.5 mm, in particular 0-0.25 mm.

In some embodiments, the centrifugal coffee brewing device may comprise a filter seal which extends outwardly from a peripheral edge of the roof portion, wherein the filter seal and the upper, vertical section of the cylinder element may define the filtration gap.

In some embodiments, the filter seal may touch the upper, vertical section of the cylinder element, wherein the surface roughness of the filter seal and/or the surface roughness of the cylinder element may result in multiple filtration gaps to allow brewed coffee to flow upwards through the filtration gap during the spinning of the spinning assembly while keeping the coffee residue in the brewing chamber.

In some embodiments, the filter seal may be not fixed to the peripheral edge and may be configured to move between an open state and a closed state, wherein in the open state the at least one filtration gap is open and in the closed state the at least one filtration gap is closed.

In some embodiments, the filter seal may be forced outwardly by the centrifugal force during spinning of the spinning assembly. An increment in RPM will increase the centrifugal force on the filter seal and will move the filter seal outwardly. The filtration gaps which are formed by the surface roughness of the cylinder element and/or filter seal decrease when the filter seal moves outwardly, because the filter seal is forced to be closer to the cylinder element. Smaller filtration gaps further increase the pressure in the brewing chamber. This allows brewing of coffee recipes that require higher pressures during the brewing process.

In some embodiments, the rotational speed of the spinning assembly may determine the degree of sealing of the filter seal, wherein an increment of the rotational speed may decrease the amount of filtration gaps, and wherein a decrement of the rotational speed increases the amount of filtration gaps.

In some embodiments, the annular wiper seal may be positioned above the filter seal.

In some embodiments, an upper seal may extend outwardly from a peripheral edge of the roof portion.

In some embodiments, the cylindrical wall may have multiple depressions on an inner side thereof.

In some embodiments, in the first, lower position the depressions may be positioned at a level of the upper seal and the upper seal may engage the inner surface of the cylindrical wall in wall areas outside the depressions but remains at a distance from the cylindrical wall at the depressions, wherein filtration gaps may be formed between the upper seal and the cylindrical wall at the depressions.

In some embodiments, the depressions may be elongate.

In some embodiments, the depressions may extend vertically.

In some embodiments, the depressions may be parallel.

In some embodiments, the cylinder element may comprise:
a first, lower conical section which may increase in diameter in an upward direction,
a second, upper conical section which may increase in diameter in an upward direction,
   wherein the second, upper conical section may have a greater slant angle than the first, lower conical section.

In some embodiments, the geometry, in particular a width and/or a depth, of each depression may vary in a vertical and/or horizontal direction.

In some embodiments, each depression may comprise a lower narrow section and an upper wider section which may be wider than the lower narrow section.

In some embodiments, the cylinder element may be movable to at least a first and a second coffee brewing position, wherein the first coffee brewing position may be above the second coffee brewing position, wherein the filtration gaps between the cylinder element and the upper seal may be wider or narrower in the first coffee brewing position than in the second coffee brewing position, allowing different filter areas for different coffee recipes.

In some embodiments, the depth of each depression may vary in the vertical and horizontal directions and more in particular may vary between 0.1-0,5 mm, in particular 0.15 -0.35 mm.

In some embodiments, the cylinder element may be movable to a third, intermediate position between the first, lower position and second, upper position, wherein the annular wiper seal may engage a lower edge of the second, upper conical section in the third, intermediate position to block an outgoing flow of coffee from the brewing chamber and to build up pressure in the brewing chamber.

In some embodiments, the cylinder element may be movable between the first, lower position and the third, intermediate position, wherein the upper seal may be able to engage the cylindrical wall at different vertical heights, and wherein the varying geometry of each depression in the vertical direction may result in varying filtration areas of the filtration gaps at said different vertical heights.

In some embodiments, the depressions may be positioned at an equal distance from each other and may form an array.

In some embodiments, the annular wiper seal may be positioned above the upper seal.

In some embodiments, the annular wiper seal may have a smaller thickness than the upper seal, allowing the annular wiper seal to be less rigid than the upper seal and to follow the geometry of each depression during an upward movement of the cylinder element relative to the chamber element in order to wipe coffee residue from an inner surface of each depression.

In some embodiments, the filter seal and upper seal may be configured to maintain concentricity between the chamber element and the cylinder element.

In this aspect, the invention further relates to a method of brewing coffee, the method comprising:
supplying ground coffee and hot water into the brewing chamber of the centrifugal coffee brewing device according to any of claims 44-61 when the cylinder element is in the first, lower position,
spinning the spinning assembly in order to brew coffee, wherein brewed coffee flows upwards through the at least one filtration gap during the spinning of the spinning assembly, while keeping the coffee residue in the brewing chamber,
moving the cylinder element from the first, lower position to the second, upper position,
spinning the chamber element in order to eject coffee residue,
moving the cylinder element from the second, upper position to the first, lower position.

The method provides the same advantages as the device.

### Hopper With Improved Impeller

In another independent aspect, the present invention relates to a hopper having an improved impeller, wherein the hopper comprises:
a bean compartment configured for holding coffee beans,
a brewer coupling for coupling the hopper with the coffee brewing device,
an impeller positioned at a lower portion of the hopper, wherein the impeller comprises a hub and blades which project outwardly from the hub, and
a surrounding wall which surrounds the impeller and forms an impeller cavity in which the impeller is located.

In some embodiments, when seen in top view the hub has a hub diameter (D1) and the surrounding wall defines a surrounding wall diameter (D2), wherein the hub diameter (D1) is at least 40 percent, in particular at least 50 percent of the surrounding wall diameter (D2).

The relatively large diameter of the hub allows a slower rotation of the impeller and a more effective use of the volume of the hopper. This results in a more predictable dosing of coffee beans. Also, the machine may shake somewhat during dosing of coffee beans but this should not result in extra beans. The slower speed also results in less variability due to shaking.

The relatively large size of the impeller reduces the chance of sticky beans bridging the impeller. In case the hub and the surrounding wall are not exactly circular, the hub diameter and the surrounding wall diameter are taken as the smallest transverse dimension of the hub respectively the surrounding wall. Current dosing hoppers rely on a relatively small impeller, which needs a high speed to throw the beans sideways for dosing. This is unpredictable in grams of bean flow per second, and the rate of flow also depends on the type and size of beans. Also, the bigger diameter of the hub allows the construction of the impeller motor in the coffee brewing device more space efficient.

In some embodiments, the hub diameter is at least 30 mm, in particular at least 40 mm. A problem which sometimes occurs with impellers of coffee bean hoppers is ‘bridging’. The coffee beans form a bridge above the impeller and do not enter the spaces between the blades of the impeller. In some embodiments, a difference between the hub diameter (D1) and the surrounding wall diameter (D2) is at least 40 mm. It was found that with a relatively large diameter of the hub and a larger diameter of the blades, this problem can be resolved or at least significantly reduced. Therefore, the dimensions of the parts are optimized constructed to the size of coffee beans, in particular relative to the longitudinal dimension of a coffee bean.

The impeller compartments between the impeller blades will be completely emptied on every passage along the bean exit. The bean exit may have about a same size and/or shape as an impeller compartment.

In some embodiments, the blades have outer tips which when seen in top view define a blade diameter of the impeller, wherein the blade diameter is at least 75 mm, more in particular at least 80 mm. The large blade diameter prevents bridging and allows a slow rotation of the impeller.

In some embodiments, the impeller has more than five blades and in particular seven blades. It was found that this makes accurate dosing, i.e. volumetric dosing, easier.

In some embodiments, the surrounding wall diameter is at least 70 mm, and in particular at least 80 mm. The larger diameter of the surrounding wall results in a smaller chute. The chute creates void space within the hopper, and with a smaller chute the void space is smaller, thereby increasing the volume of the bean compartment of the hopper. For large coffee brewing devices, the surrounding wall diameter may be considerably larger.

In some embodiments, the hopper further comprises a circumferential side wall and a chute, wherein a lower portion of the circumferential side wall goes over in the chute and a lower portion of the chute goes over in the surrounding wall.

In some embodiments, the chute tapers outwardly in an upward direction, wherein the chute has a chute diameter which increases in an upward direction, and wherein the chute diameter at a lowest part of the chute is at least 70 percent of an inner diameter of the circumferential side wall. It was found that a relatively small chute result in more effective use of the volume of the hopper and therefore in an increase in the volume of the bean compartment.

In some embodiments, the hopper does not comprise a chute. The circumferential side wall may go over directly in the surrounding wall of the impeller. This creates a simple construction of the hopper with an efficient use of the inner volume and little or no void space. A chute on the other hand allows a larger hopper for a same diameter of the impeller and for a same footprint of the hopper, i.e. for a same diameter of a support platform on the coffee brewing device, the support platform configured to support the hopper.

In some embodiments, the hopper further comprises a bottom wall and a bean exit in the bottom wall, wherein when seen in top view the bean exit is located radially within the blade diameter, wherein during a rotation of the impeller, the impeller blades move over the bean exit and the beans drop through the bean exit. It was found that this provides a more effective way of dosing than an exit which is located to the side of the impeller. Instead of by centrifugal force, the coffee beans drop through the exit by gravity. This allows a lower rotation speed of the impeller because centrifugal force is not required. The lower speed allows more accurate dosing.

In some embodiments, the hopper comprises a fixed bottom wall and a rotatable bottom valve member, the rotatable bottom valve member being rotatable relative to the fixed bottom wall, wherein the fixed bottom wall comprises a fixed bean exit, wherein the rotatable bottom valve member comprises a first holding member configured to engage a second holding member of the coffee brewing device, wherein the hopper is configured to be engaged with the coffee brewing device and to subsequently be rotated about a vertical axis, wherein during said rotation the first and second holding member hold the rotatable bottom valve member while the rest of the hopper is rotated, wherein during said rotation the fixed bean exit rotates together with the rest of the hopper relative to the rotatable bottom valve member between a closed position in which the valve member closes the fixed bean exit and an open position in which the valve member does not close off the fixed bean exit. It was found that this embodiment provides a sturdy and reliable mechanism to keep the bean exit closed when the hopper is uncoupled from the coffee brewing device and to open the bean exit when the hopper is placed on the coffee brewing device. This construction allows exchange of one hopper for the other, e.g. a hopper with regular beans for a hopper with decafe beans, without any beans of the removed hopper staying behind in the coffee brewing device, which beans would then pollute the first cup from the new hopper.

The rotatable bottom valve member may form a bottom wall of the hopper. Also, the rotatable bottom valve member may comprise a rotatable bean exit. In that embodiment, the fixed bottom wall may rotate from a first, non-aligned position to a second, aligned position in which the fixed bean exit is aligned with the rotatable bean exit.

In some embodiments, the hopper further comprises a drive coupling on a bottom side of the hopper, wherein the drive coupling is configured to be coupled with an impeller drive assembly which is located in the coffee brewing device, wherein the drive coupling is connected to the impeller. This provides an efficient way of driving the impeller in a controllable way, the control lying with the control unit of the coffee brewing device.

In some embodiments, the hopper further comprises a roof member which is positioned above the impeller and directly above the bean exit, wherein the roof member is in particular connected to a side wall of the hopper and extends over a horizontal distance inward from the side wall. The roof member prevents or reduces accidental beans dropping in the grinder when not dosing. The roof member keeps the impeller compartment directly above the bean exit empty from beans which allows a clean exchange of one hopper for the other.

In some embodiments, the roof member extends over a circumferential angle of at least twice the circumferential angle of an impeller compartment. In this way, the impeller compartment which is above the bean exit can always be kept empty. This makes it possible to exchange hoppers without spilling or leaking beans.

In some embodiments, the roof member comprises a leading edge which when seen in top view is oriented at a sharp angle (α) relative to the blade which is directly underneath the leading edge, such that the leading edge pushes any coffee bean which hits the leading edge during a rotation of the impeller in an outward direction. This results in less chance of bean jamming and less chance of bean bridging.

In some embodiment, when seen in top view the roof member spans a circumferential angle of at least 70 degrees. Because of the relatively large roof member, a tight clearance between the impeller paddles and the roof member is not required, thereby reducing the risk of beans jamming the mechanism.

In some embodiments, the impeller blades are flexible and are in particular made of rubber. This prevents jamming. In the case that a coffee beans may get stuck, the blade deforms and the coffee bean is then gently pushed upwards so that it becomes unstuck.

In some embodiments, the surrounding wall which surrounds the impeller is lower than the impeller blades, and wherein when seen in side view the impeller blades extend to above a lowest part of the chute. If there is a clear transition between the surrounding wall and the chute the impeller blades extend to above the transition. It was found that with a lower rotational speed of the impeller, the coffee beans are not ejected outwardly away. This allows the surrounding wall to be lower, thereby increasing the effective volume of the hopper. Also, the lower surrounding wall allows feeding of the impeller not only from the top, but also from the sides.

The present invention also relates to a coffee brewing device or a grinder device configured to receive the hopper as claimed. In case of a grinder device, the grinder device comprises a grinder, but not a brewing assembly. The grinder device simply grinds coffee to be used in a separate coffee brewing device, which may be non centrifugal. The coffee brewing device or grinder device may comprise a single, exchangeable hopper, a single non-exchangeable hopper, two hoppers, each having an impeller, wherein the two hopper are fixed or exchangeable. In case of two hoppers, they may be integrated in a single housing.

In some embodiments of the coffee brewing device or grinder device, the drive is configured for rotating the impeller at a rotational speed of less than 25 rpm, in particular less than 20 rpm, more in particular about 15 rpm.

In some embodiments, the coffee brewing device or grinder device further comprises at least one weight sensor and in particular a plurality of weight sensors for weighing the hopper including the coffee beans in the hopper.

In some embodiments, the coffee brewing device or grinder device further comprises a support platform for the hopper, wherein when seen in top view the weight sensors are located at a circumference of the support platform. It was found that this allows a more precise weighing of the hopper plus beans.

In some embodiments, the coffee brewing device or grinder device comprises a grinder and a control unit which is configured for performing the following sequence of steps:
a) weighing the hopper including the coffee beans for a first time with the weight sensor(s),
b) rotating the impeller for a first time period, thereby feeding coffee beans from the hopper to the grinder,
c) weighing the hopper including the coffee beans for a second time to determine a weight difference,
d) evaluating the weight difference and when the weight difference is smaller than a target weight difference, rotating the impeller for a second time period to feed further coffee beans to the grinder.

In some embodiments, the control unit comprises a calibration module configured for using the weight difference determined in the sequence of steps for calibrating the first time period for a next cup of coffee, wherein when the weight difference is above a first threshold value, the first time period or rotational speed of the impeller is increased, and when the weight difference is below a second threshold value, the first time period or rotational speed reduced. In this way, the dosing of ground coffee can be made more accurate with each coffee cup that is made. This is in particular an advantage because it is not always known what kind of beans are in the hopper. Different beans have different dosing properties. These variations can then be reduced per cup of coffee that is made.

In some embodiments, the control unit is configured to stop the grinder during the weight measurement. This allows a more precise weight measurement.

In some embodiments, the coffee brewing device or grinder device comprises a hopper coupling, in particular a bayonet coupling, for coupling the hopper to the coffee brewing device, wherein the coupling is configured to first allow the hopper to engage the coupling, followed by a rotation of the hopper about a vertical axis to secure the hopper to the coffee brewing device, wherein the coffee brewing device comprises a second holding member configured to engage a first holding member of a rotatable bottom valve member of the hopper, the rotatable bottom valve member being rotatable relative to the rest of the hopper, wherein the second holding member is configured to hold the rotatable bottom valve member during the rotation of the hopper about the vertical axis.

In some embodiments, the control unit is configured to rotate the impeller and the grinder simultaneously. This may result in less variability of the grind size.

In some embodiments, the control unit is configured to vary the grind size of the grinding during the dosing, in order to form a layered coffee cake in the brewing chamber.

The present invention also relates to a combination of the coffee brewing device or grinder device and the hopper.

### Coffee Bean Grinder Assembly

The present invention also relates to a coffee bean grinder assembly. This is essentially a combination of the coffee been grinder and the drive assembly, but without the spinning assembly and every other part that is relates to brewing coffee. The coffee bean grinder assembly grinds coffee for a coffee brewer which may b entirely separate.

The coffee bean grinder device comprises:
a coffee bean grinder comprising a first burr and a second burr, wherein the first and second burr are rotatable relative to one another about a grinder axis,
a drive assembly configured for rotating the coffee bean grinder about the grinder axis, wherein the drive assembly comprises a stator and a rotor configured to rotate about a rotor axis (56), wherein the rotor axis is coaxial with the grinder axis

In some embodiments, the drive assembly comprises a direct drive electromotor, the direct drive electromotor comprising multiple coils which are positioned in a circular arrangement on the stator, each coil having a main axis which is oriented radially, and wherein a plurality of magnets are positioned in a circular arrangement on the rotor.

In some embodiments, at least a part of the coffee bean grinder is positioned at a same vertical level as the drive assembly.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1 shows an isometric view of the centrifugal coffee brewing device according to the invention.

FIG. 2a shows a sectional view of the spinning assembly in the brewing configuration.

FIG. 2b shows a sectional view of the spinning assembly in an ejecting configuration.

FIG. 3a shows an isometric sectional view of the spinning assembly in the brewing configuration.

FIG. 3b shows an isometric sectional view of the spinning assembly in an ejecting configuration.

FIG. 4 shows a sectional top view of the coffee bean grinder and drive assembly.

FIG. 5a shows an sectional view of the heater-gutter device.

FIG. 5b shows an isometric sectional view of the heater-gutter device.

FIG. 6a shows an isometric bottom view of the heater-gutter device.

FIG. 6b shows an isometric top view of the heater-gutter device.

FIG. 7 shows an isometric sectional view of the spinning assembly and spraying element.

FIG. 8 shows a sectional view of the hot water supply assembly.

FIG. 9 shows an isometric sectional view of the hot water supply assembly.

FIG. 10 shows a sectional view of the spinning assembly.

FIG. 11a shows a sectional view of the chamber element and cylinder element.

FIG. 11b shows a close-up of the cylinder element and roof portion.

FIG. 12 shows a sectional view of the spinning assembly.

FIG. 13a shows a sectional view of the chamber element and cylinder element.

FIG. 13b shows a close-up view of the cylinder element and roof portion.

FIG. 13c shows a close-up view of the cylinder element and filter seal.

FIG. 14a shows a sectional view of the cylinder element.

FIG. 14b shows a sectional view of the chamber element and cylinder element.

FIG. 15 shows a close-up view of the chamber element and cylinder element.

FIG. 16 shows a view of a coffee brewing device with a further embodiment of a hopper.

FIG. 17 shows an isometric view of the hopper including a top portion of the coffee brewing device.

FIGS. 18 and 19 shows an isometric view and a top view of the hopper.

FIG. 20 shows a sectional side view of the hopper with an upper part of the coffee brewing device.

FIG. 21 shows a bottom view of the coffee brewing device with partial cut-away to sow a part of the hopper.

FIGS. 22 and 23 show a bottom view and a sectional view of the hopper in an open state.

FIGS. 24 and 25 show a bottom view and a sectional view of the hopper in a closed state.

### DETAILED DESCRIPTION OF THE FIGURES

### 1. Drive Assembly and Coffee Bean Grinder

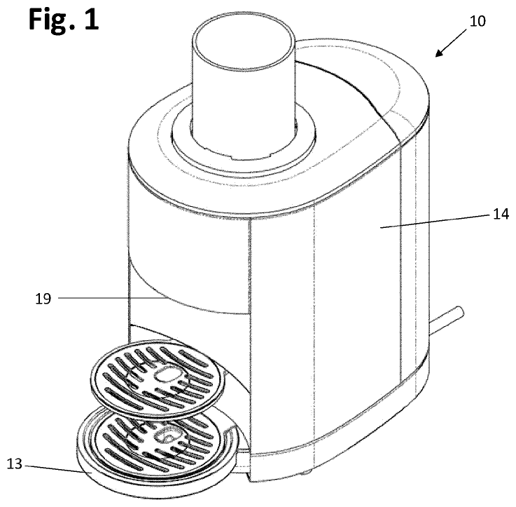

Turning to FIGS. 1-3, a centrifugal coffee brewing device 10 (also simply referred to as the device 10) is shown. The device comprises a housing 14 which covers the various parts. A drip tray 13 for supporting a coffee cup is provided at the front side. A coffee outlet 19 is provided above the tray.

The device 10 comprises a spinning assembly 20 which is rotatable about a main axes 22. The main axis 18 may be vertical but it is conceivable that the main axis is slightly inclined. The spinning assembly 20 comprises a chamber element 24 and a cylinder element 100. The chamber element 24 and the cylinder element 100 form a brewing chamber 30. The chamber element further comprises a bottom wall 25 and a roof portion 26.

The device 10 comprises a coffee bean grinder 40 for grinding coffee beans into coffee ground. The coffee bean grinder comprises a first burr 42 and a second burr 44 which is positioned within the first burr 42. The first burr 42 and second burr 44 are rotatable relative to one another about a grinder axis 46. The grinder axis 46 is coaxial with the main axis 22. In the shown embodiment, the first burr 42 is an outer burr and the second burr 44 is an inner burr. However, it is also possible to use a grinder having flat burrs, wherein the first burr is positioned on top of the second burr.

The device 10 further comprises a drive assembly 50 for rotating the spinning assembly 20 about the main axis 22 for centrifuging the coffee. The drive assembly comprises a stator 52 and a rotor 53. The rotor 53 is connected to the spinning assembly 20, in particular to a roof portion 26 of the chamber element 24, and is configured to rotate about a rotor axis 54. The rotor axis 54 is coaxial with the main axis 22 and the grinder axis 46. The centrifugal coffee brewing device 10 does not comprise a separate grinder drive for rotating the first and second burr relative to one another.

The drive assembly 50 is also configured for rotating the second burr 44 about the grinder axis 46. The second burr 44 is connected to the chamber element 24 of the spinning assembly 20. An axle 28 which extends downward from the second burr 44 is connected to the roof portion 26 of the chamber element 24. Therefore, the second burr 44 is driven by the drive assembly 50 via the roof portion 26 of the spinning assembly 20 and rotates together with the chamber element.

The coffee bean grinder 40 is positioned directly above the spinning assembly 20 and at least a part of the coffee bean grinder 40 is positioned at a same vertical level 59 as the drive assembly 50.

The drive assembly 50 performs a further function of increasing the temperature of the coffee bean grinder 40 to reduce or prevent condensation in the coffee bean grinder 40. In particular the temperature of the second burr 44 and/or first burr 42 is increased using radiative and/or conductive heat transfer from the drive assembly 50. The second burr 44 of the coffee bean grinder 40 is thermally connected to the roof portion 26 of the chamber element 24. Heat is therefore transferred from the drive assembly 50, through the roof portion 26, to the second burr 44 to heat the coffee bean grinder 40.

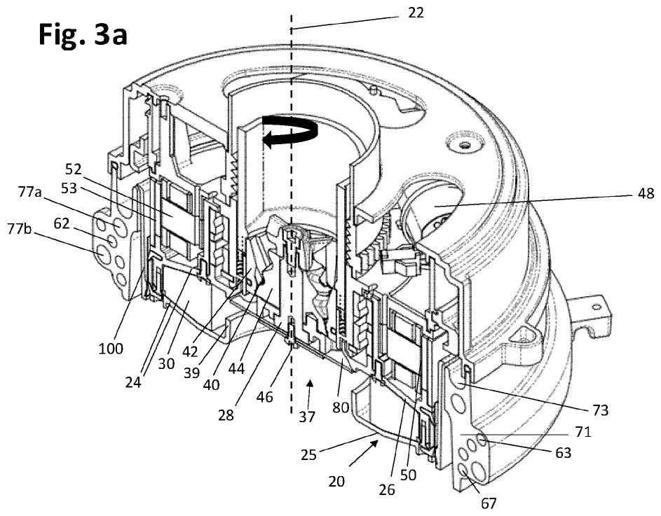

Turning to FIG. 4, a sectional top view of the coffee bean grinder 40 and the drive assembly 50 are shown. The stator 52 is positioned within the rotor 53 and the rotor 53 extends around the stator 52. In FIG. 4, multiple coils 55 are positioned in a circular arrangement 56 on the rotor 53 and multiple magnets 57 are positioned in a circular arrangement 58 on the stator 52. The coils 55 are positioned within the magnets 57. Each coil has a main axis 155 which is oriented radially. In another embodiment, multiple coils may be positioned in a circular arrangement on the stator and multiple magnets may be positioned in a circular arrangement on the rotor.

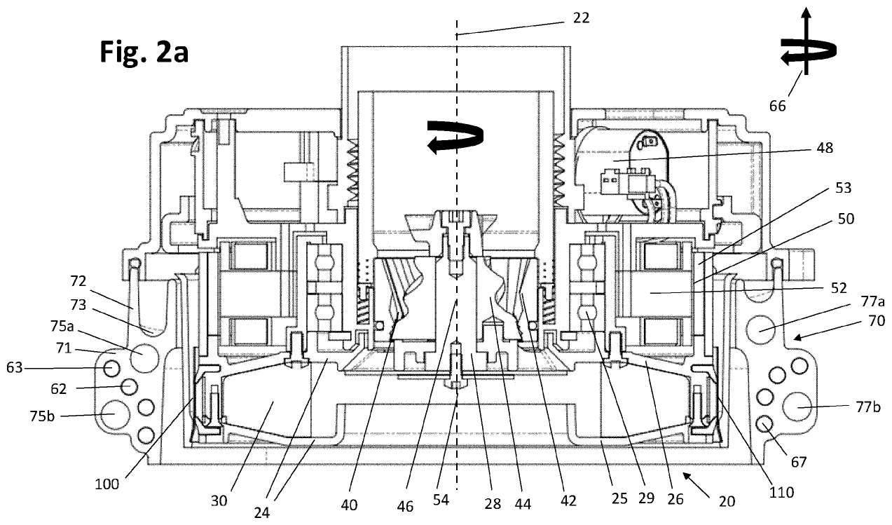

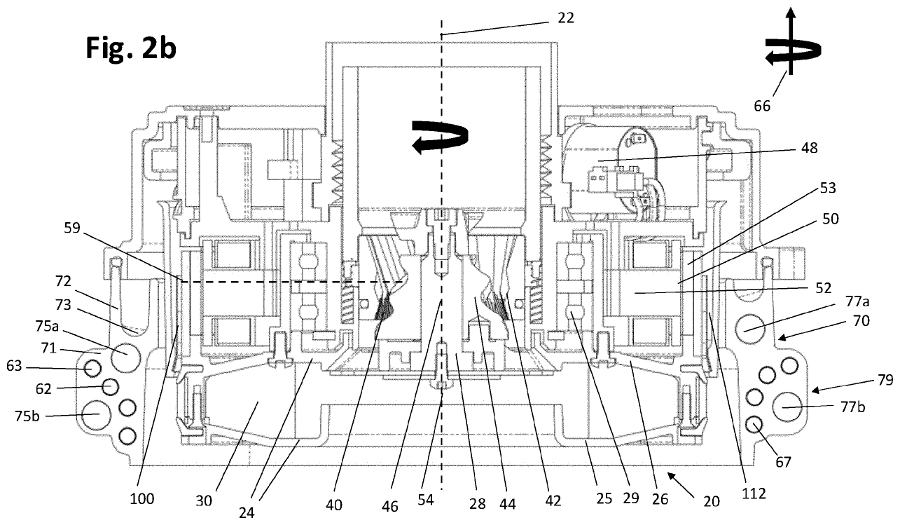

Returning to FIGS. 2 and 3, the spinning assembly 20 comprises at least one brewer bearing 29. The at least one brewer bearing 29 provides radial and axial support to the spinning assembly 20, to the rotor 53 of the drive assembly 50 and to the second burr 44. The stator 52 extends around the at least one brewer bearing 29.

The chamber element 24 and the cylinder element 100 are movable relative to each other in the axial direction. More in particular, the chamber element 24 is fixed in the axial direction and the cylinder element 100 is movable in the axial direction.

FIGS. 2a and 3a show the cylinder element 100 in a first, lower position 110, positioned on the same vertical level as the chamber element 24 forming the brewing chamber 30. FIGS. 2b and 3b show the cylinder element 100 in a second, upper position 112, positioned at a higher vertical level than the chamber element 24. Coffee residue may be ejected from the brewing chamber 30 when the cylinder element 100 is in the second, upper position 112. It is ejected by the centrifugal force of the spinning chamber element 24 and drops into a residue tray 140.

The first burr 42 and the second burr 44 are also movable relative to each other in the axial direction. More in particular, the second burr 44 is fixed in the axial direction and the first burr 42 is movable in the axial direction by a grinder drive 48. The first burr 42 may be moved in the axial direction to adjust the distance between the first burr 42 and the second burr 44. FIGS. 2a and 3a show the first burr 42 close to the second burr 44 and FIGS. 2b and 3b show the first burr 42 further away from the second burr 44.

A varying distance between those elements allows grinding to different sized coffee ground particles for different coffee recipes. Additionally, it also supports the cleaning function of the coffee bean grinder 40. It also reduces the wear and tear of the coffee bean grinder 40. Friction between both elements is prevented when the rotational speed of the second burr 44 and the brewing chamber 30 increases.

The present invention further relates to a method of brewing coffee, the method comprising:
providing coffee beans to the coffee bean grinder of the centrifugal coffee brewing device 10,
spinning the spinning assembly with the drive assembly in order to grind the coffee beans,
supplying hot water in the brewing chamber,
spinning the spinning assembly with the drive assembly in order to brew coffee.

### 2. Heater-Gutter Device

Returning to FIGS. 2 and 3, the centrifugal coffee brewing device 10 may comprise a heater-gutter device 70 configured for supplying hot water to the brewing chamber 30 and for increasing the temperature of the brewed coffee. The heater-gutter device 70 comprises a heater 79 and a gutter 73. The heater-gutter device 70 further comprises an annular device 71, a helicoidal duct 62 and at least one electric heating element 76.

The annular device 71 defines a gutter wall 72 which defines a gutter 73. The gutter 73 is configured to receive brewed coffee which is expelled from the spinning assembly 20. Brewed coffee travels through the gutter 73 to a spout 74, because the gutter 73 slopes down to the spout 74.

The helicoidal duct 62 may be located in the annular device 71 and extends in about the main axis 22. The helicoidal duct may comprises multiple windings located at different vertical levels and an inlet 64 and outlet 65. The inlet 64 is connected to a lower, upstream winding 67 and the outlet is connected to a upper, downstream winding 63.

The electric heating element 76 is also located within the annular device 71 and extends about the main axis 22. The at least one electric heating element 75 is configured for heating the gutter wall 72 and for heating water in the helicoidal duct 62. Water is pumped through the helicoidal duct 62 by a pump 60 prior to being introduced in the brewing chamber 30. The pump 60 is configured to circulate water through the internal helicoidal duct 62 from the inlet 64 to the outlet 65 in an upwardly spiraling direction 66. The heated gutter all 72 reduces the temperature losses of the brewed coffee after being expelled from the spinning assembly 20.

In an embodiment of the invention, the electric heating element 75 comprises at least two heating elements, namely a first heating element 77a and a second heating element 77b. The heating elements are independently controllable and each comprise a separate power supply 76a, 76b. The first heating element 77a is connected to a first power supply 76a with a range of 200-600 Watt. The second heating element 77b is connected to a second power supply 76b with a range of 700-1500 Watt.

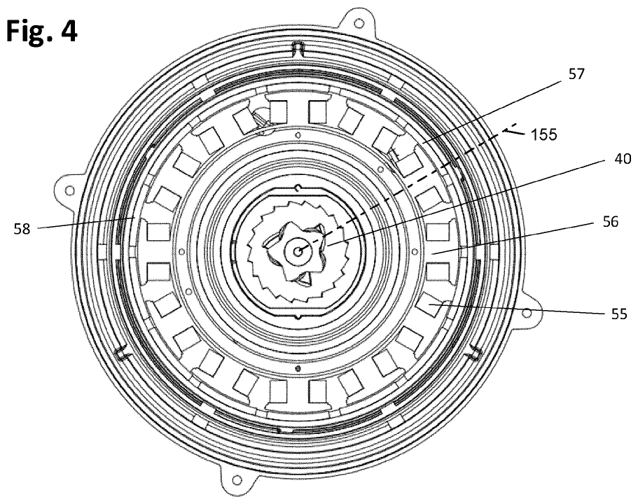

Turning to FIGS. 6a and 6b, the inlet 64 and outlet 65 may be positioned below the heater-gutter device 70 and next to the second power supply 76b. The first power supply 76a is positioned above the heater-gutter device 70.

Returning to FIGS. 2 and 3, the upper, downstream winding 63 of the helicoidal duct 62 is positioned lower than the upper most heating element and further away from the gutter than the uppermost heating element. In addition, at least one heating element is positioned directly below the gutter. The above mentioned layout of the annular device is configured to prevent that the temperature of the gutter is reduced by the circulating water in the helicoidal duct. This ensures that the temperature of the gutter is sufficient to increase the temperature of the brewed coffee to a desired serving temperature.

The first heating element 77a comprises a first heating winding 75a and the second heating element 77b comprises a second heating winding 75b. The first heating element 77a is located above the second heating element 77b.

The helicoidal duct 62 comprises at least three windings, and more in particular four windings. The lower, upstream winding 67 of the helicoidal duct 62 is positioned lower than the lowermost heating element, more in particular lower than the second hearing element 77b.

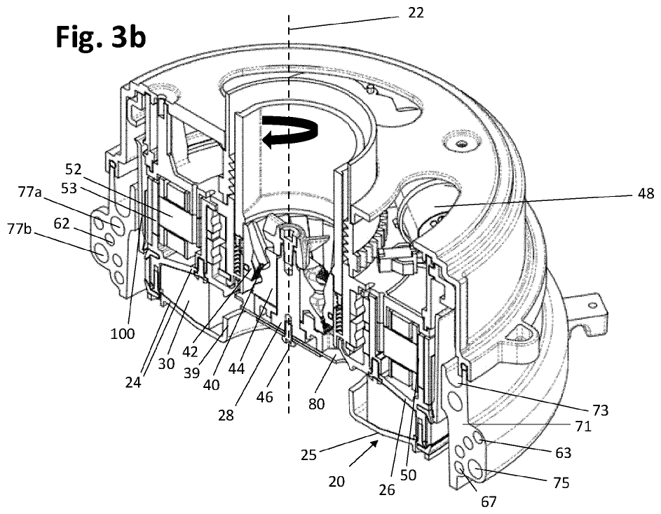

Turning to FIGS. 5a and 5b, in another embodiment of the invention, the annular device 71 may comprise at least two annular body's, an upper annular body 132 and a lower annular body 133. The upper annular body 132 is positioned above the lower annular body 133. The upper annular body 132 defines the gutter wall 72 and the helicoidal duct 62 is located in the lower annular body 133. An O-ring 135 is positioned between the upper annular body 132 and the lower annular body 133 to prevent leakage between the annular body's.

The electric heating element 75 in this embodiment may comprise at least two heating elements, namely a first heating element 77a and a second heating element 77b. The heating elements are independently controllable and each comprise a separate power supply 76a, 76b. The first heating element 77a is connected to a first power supply 76a with a range of 200-600 Watt. The second heating element 77b is connected to a second power supply 76b with a range of 700-1500 Watt. An embodiment wherein both annular body's 132, 133 are heated with a single heating element 75 may also be sufficient to increase the temperature of cold water and heat the gutter wall.

An annular device 71 with two annular body's increases the freedom to regulate the temperature of the hot water supplied to the brewing chamber 30 and the temperature of the gutter wall 72 separately. At the same time, the design of the annular device 71 still prevents that the gutter 73 is cooled by cold water in the lower, upstream winding 67.

In operation, the method of brewing coffee comprises:
providing ground coffee in the centrifugal coffee brewing device (10) according to any of claims 15-23,
circulating cold water through the helicoidal duct of the heater-gutter device with the pump,
supplying hot water in the brewing chamber,
spinning the spinning assembly in order to brew coffee,
   wherein the heater heats the relatively cold water in the helicoidal duct, the gutter, and the brewed coffee in the gutter, and
   wherein the cold water circulates through the helicoidal duct in an upwardly spiraling direction, providing hot water at the outlet of the helicoidal duct.

### 3. Hot Water Supply Assembly

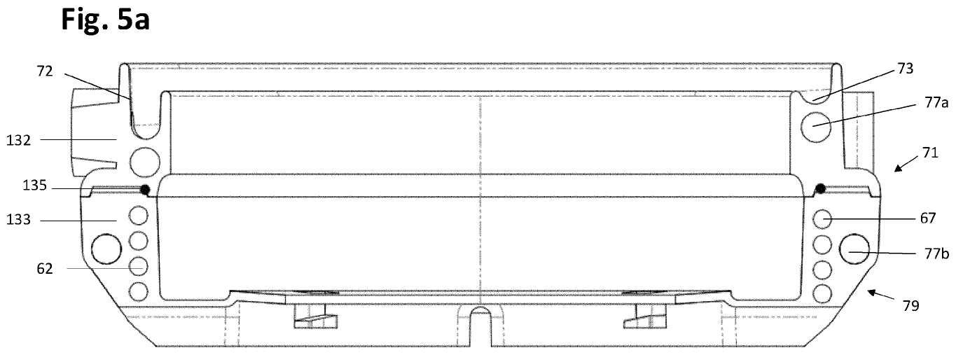

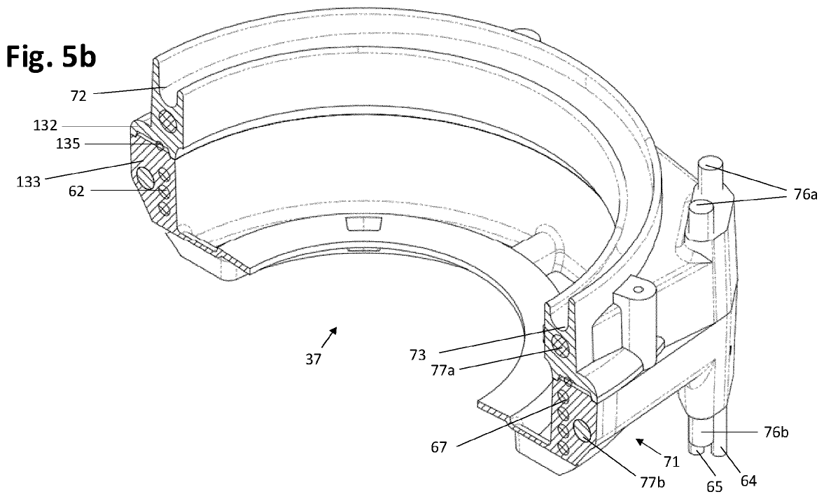

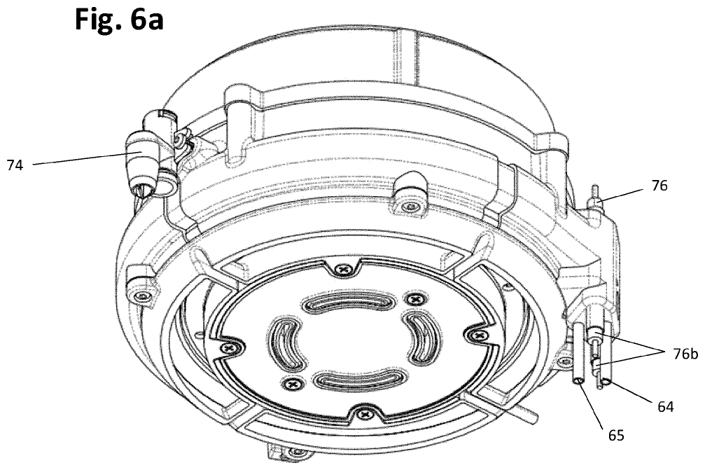

Turning to FIGS. 7-9, the device may comprise a hot water supply assembly 90 for supplying hot water into the brewing chamber 30. The hot water supply assembly 90 comprises:
a spraying element 92 configured to spray the hot water into the brewing chamber, wherein the spraying element comprises at least one nozzle 94,
a supply channel 96 which is configured to supply hot water to the spraying element, wherein a first section 98 of the supply channel extends below the brewing chamber, and wherein a second section 99 of the supply channel extends upward from the first section and extends through a central aperture 37 in a bottom wall 38 of the brewing chamber.

Spinning assembly 20 comprises an upstanding wall portion 39 which extends upward from the bottom wall 25. The upstanding wall portion 39 defines the central aperture 37 in the bottom wall 38 and prevent that coffee ground, coffee residue, water or brewed coffee leaves the brewing chamber through the central aperture 37. The hot water supply assembly 90 is configured to supply the hot water into the brewing chamber 30 over the upstanding wall portion 39 using the nozzle 94 which is configured to spray hot water over a horizontal distance 95.

The spraying element 92 may comprise multiple nozzles 94 which are positioned next to each other, and in particular at a horizontal distance from one another. The multiple nozzles 94 are configured to spray hot water at different angles 97a, 97b, 97c, allowing an evenly distributed supply of hot water onto a coffee bed 31 in the brewing chamber.

The brewing chamber 30 may be coaxial with the main axis 22 and may have an annular shape. The spraying element 92 may be positioned eccentrically from the main axis 22 to reduce the spraying distance to the brewing chamber 30. The spraying element 92 close to the upstanding wall portion 39 also provides more freedom to select suitable spraying angles, because it simplifies spraying over the upstanding wall portion 39.

In operation, the method of brewing coffee comprises:
providing ground coffee in the centrifugal coffee brewing device (10) according to any of claims 36-41,
providing hot water to the spraying element with the supply channel,
spraying hot water into the brewing chamber,
spinning the spinning assembly in order to brew coffee.

In the method hot water is supplied into the brewing chamber over an upstanding wall portion.

### 4. Simplified Filter Concept

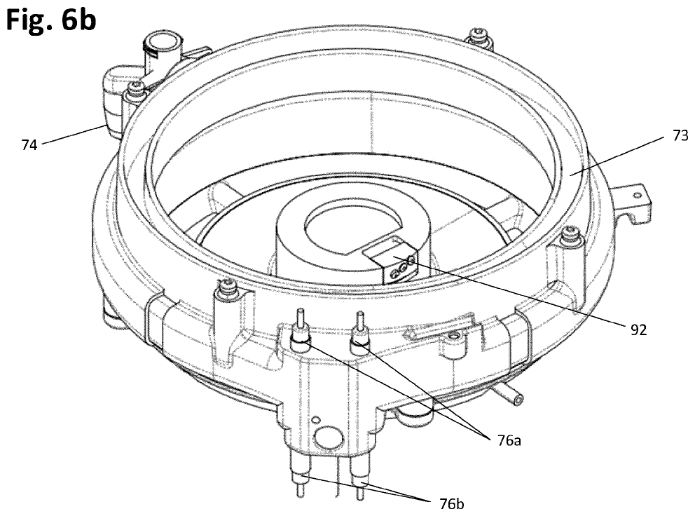

Turning to FIGS. 10-15, the spinning assembly 20 of the centrifugal coffee brewing device 10 comprises a chamber element 24 and a cylinder element 100, 200. The spinning assembly 20 is rotatable about a main axis 22. The cylinder element 100, 200 comprises a cylindrical wall 102, 202. The chamber element 24 comprises a bottom wall 25 and a roof portion 26. The chamber element 24 and the cylinder element 100, 200 form a brewing chamber 30 and are movable relative to one another. At least the cylinder element 100, 200 is movable in a vertical direction 101 along the main axis 22. The chamber element 24 may be stationary in the vertical direction and may be configured to only rotate about the main axis 22.

Returning to FIGS. 2a and 3a, the cylinder element 100, 200 in a first, lower position 110 relative to the chamber element 24 is shown. In the first, lower position 110, the cylinder element 100, 200 forms a circumference of the brewing chamber 30 and the spinning assembly 20 is in a brewing configuration. The lower seal 105 engages the cylindrical wall 102, 202 in a bottom position 109 to prevent that coffee leaves the brewing chamber 30 between the bottom wall 25 and the cylindrical wall 102, 202.

Returning to FIGS. 2b and 3b, the cylinder element 100, 200 in a second, upper position 112 relative to the chamber element 24 is shown. The brewing chamber 30 is open in the second, upper position 112. The coffee residue can be ejected by spinning the chamber element 24 when the brewing chamber 30 is open. Ejected coffee residue may be collected in a residue tray 140 below the spinning assembly 20.

Returning to FIGS. 10-15, the roof portion 26 comprises a peripheral edge 27, 217, 227. The peripheral edge 27, 217, 227 and the cylindrical wall 102, 202 define at least one aperture 113, 210 between them when the cylinder element 100, 200 is in the first, lower position. At least one filtration gap 124, 212, 214 is formed by the at least one aperture 113, 210 between the peripheral edge 27, 217, 227 and the cylindrical wall 102, 202. The at least one filtration gap 124, 212, 214 allows brewed coffee to flow upwards through the filtration gap 124, 212, 214 during the spinning of the spinning assembly 20 while keeping the coffee residue in the brewing chamber 30.

The cylindrical wall 102, 202 extends above the roof portion 26 when the cylinder element 100, 200 is in the first, lower position 110. Further, the cylinder element 100, 200 also comprises a conical section 106, 204 which increases in diameter 107 in an upward direction. The conical shape forces the brewed coffee to travel upwards along the inner surface of the cylinder element 100, 200 outside the brewing chamber 30 during spinning of the spinning assembly 20. Upwardly traveling brewed coffee is guided to the gutter 73 to be served as a cup of coffee.

The size of the at least one filtration gap 124, 212, 214 and the rotational speed of the spinning assembly 20 determine the pressure in the brewing chamber 30. Different brewing chamber pressures allow brewing of different coffee recipes. The centrifugal coffee brewing machine 10 is therefore capable of brewing different coffee recipes without any manual adjustments of the user.

The cylinder element 100, 200 does not comprise holes which extend through the cylindrical wall 102, 202 from the inside to the outside. It was found that a cylinder element with holes might be more challenging to clean after each serving. Holes may get clogged, reducing the filtering capacity, and differently flavored coffee could be mixed. This could negatively affect the quality of a cup of coffee.

The spinning assembly 20 also comprises an annular wiper seal 114 which is connected to the roof portion 26 of the chamber element 24. It is configured to wipe the coffee residue from the cylinder element 100, 200 when the cylinder element 100, 200 is moved from the first, lower position 110 to the second, upper position 112.

### First Embodiment

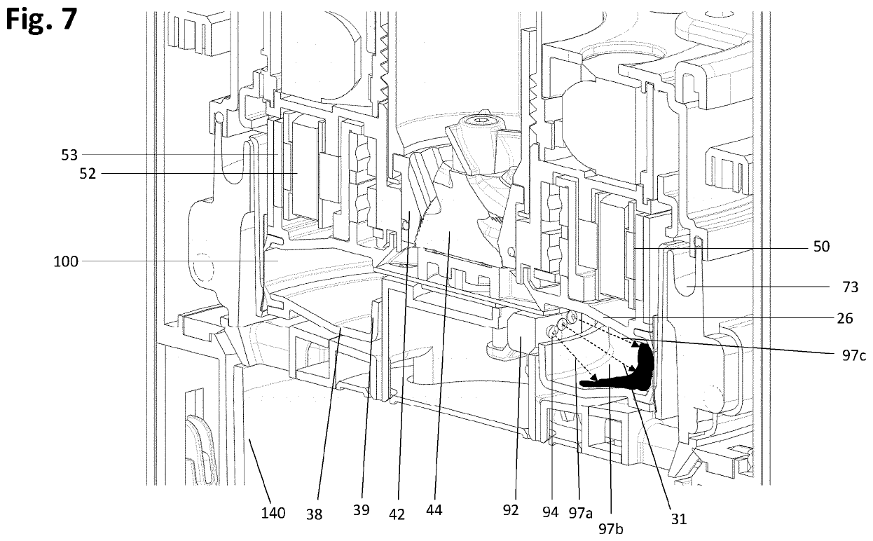

Returning to FIGS. 10, 11a and 11b, in the first embodiment of the simplified filter, the cylinder element 200 comprises a vertical section 206. The vertical section 206 of the cylinder element 200 comprises a first, lower vertical section 207 and a second, upper vertical section 208. The second, upper vertical 208 section is located inwardly from the lower, vertical section 207 of the cylinder element 200. An annular wiper seal 114 may be positioned above the upper, vertical section 208.

The inwardly extending upper, vertical section 208 and the peripheral edge 217 define an annular aperture 210. The distance between the cylinder wall 202 and the peripheral edge 217 of the roof portion is 0-0.5 mm, in particular 0-0.25 mm. A filtration gap 212 is formed by the annular aperture 210. The relatively small width of the filtration gap 212 allows brewed coffee to flow upwards while keeping coffee residue in the brewing chamber 30.

### Second Embodiment

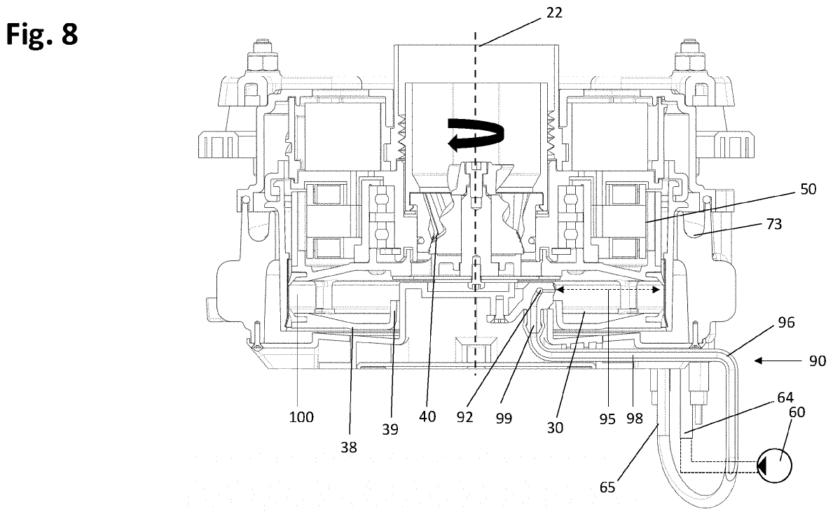

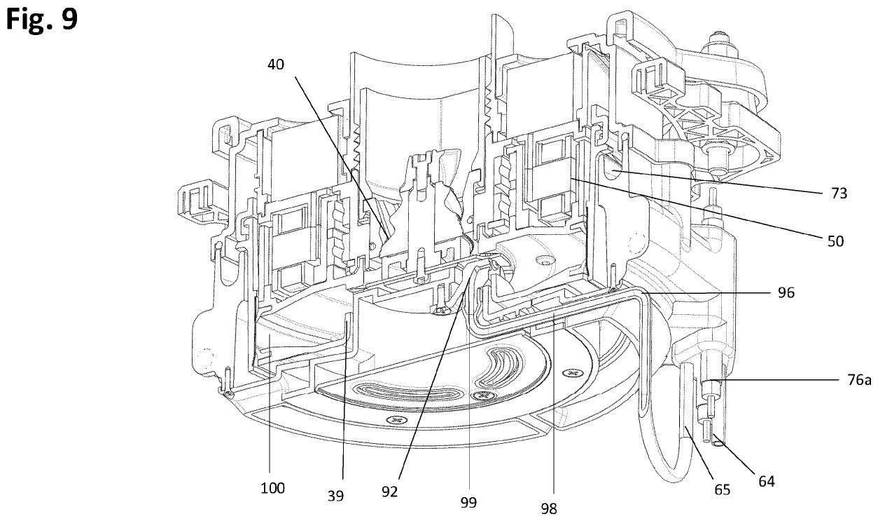

Returning to FIGS. 12 and 13a-13c, in the second embodiment of the simplified filter, the cylinder element 200 also comprises a vertical section 206. The vertical section 206 of the cylinder element 200 comprises a first, lower vertical section 207 and a second, upper vertical section 208. The second, upper vertical 208 section is located inwardly from the lower, vertical section 207 of the cylinder element 200.

The inwardly extending upper, vertical section 208 and the peripheral edge 217 define an annular aperture 210. The roof portion 26 of the chamber element 24 comprises a filter seal 220 which extends outwardly from a peripheral edge 227 of the roof portion 26, wherein the filter seal 220 and the upper, vertical section 208 of the cylinder element 200 define the at least one filtration gap 214.

The filter seal 220 touches the upper, vertical section 208 of the cylinder element 200. The surface roughness of the filter seal 220 and/or the surface roughness of the cylinder element 200 results in multiple filtration gaps 214 to allow brewed coffee to flow upwards 215 through the filtration gaps 214 during the spinning of the spinning assembly 20 while keeping the coffee residue in the brewing chamber 30.

FIG. 13c shows a schematical view of the surface roughness of the filter seal 220 and the surface roughness of the cylinder element 200. Brewed coffee is allowed to travel upwards in a flow 215 because both elements do not perfectly align. However, the filtration gaps 214 formed by the surface roughness is too small to allow coffee residue to flow upwards.

The filter seal 220 is flexible and is configured to flex between an open state and a closed state. In the open state the at least one filtration gap 214 is open and in the closed state the at least one filtration gap 214 is closed. The filter seal 220 is bendable by the pressure of brewed coffee and coffee residue. An increment in pressure forces the filter seal 220 to bent upwards. Resulting in smaller filtration gaps 214, caused by the shape of the filter seal 220. Smaller filtration gaps 214 will further increase the pressure in the brewing chamber 30. An annular wiper seal 114 may be positioned above the filter seal 220.

### Third Embodiment

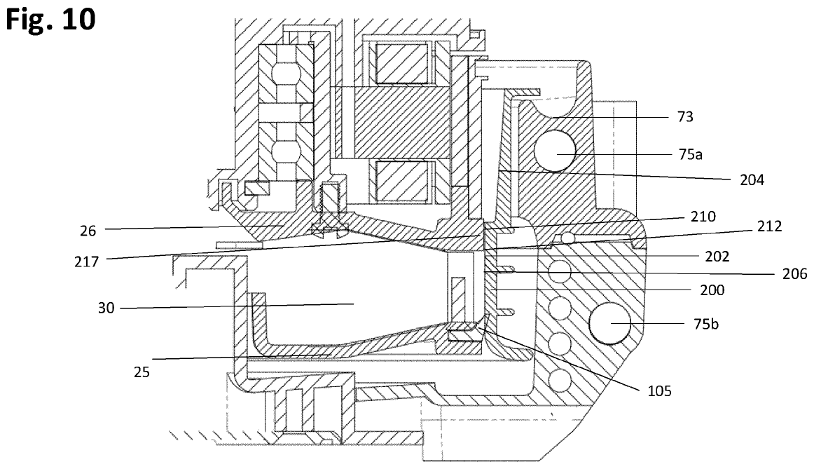

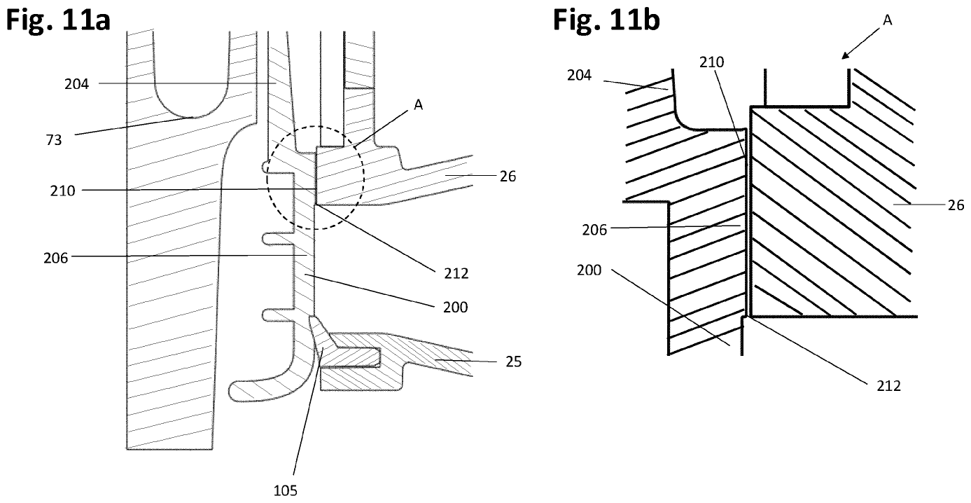

Returning to FIGS. 14a, 14b and 15, in the third embodiment of the simplified filter, the spinning assembly 20 further comprises an upper seal 104 which extends outwardly from a peripheral edge 27 of the roof portion 26 of the chamber element 24. The upper seal 104 is configured to maintain concentricity between the chamber element 24 and the cylinder element 100.

The cylindrical wall 102 comprises multiple depressions 120 on an inner side of the cylindrical wall 102. The depressions 120 are positioned at a level of the upper seal 104 when the cylindrical wall 102 is in a first, lower position 112.

The upper seal 104 engages the inner surface of the cylindrical wall 102 in wall areas 122 outside the depressions 120 but remains at a distance from the cylindrical wall 102 at the depressions 120. As a result, filtration gaps 124 are formed between the upper seal 104 and the cylindrical wall 102 at the depressions 120. The filtration gaps 124 allow brewed coffee to flow upwards through the filtration gaps 124 during the spinning of the spinning assembly 20 while keeping the coffee residue in the brewing chamber 30.

The cylinder element 100 comprises a conical section 106 which increases in diameter 107 in an upward direction. The conical shape of the cylinder element 100 forces the brewed coffee to travel upwards along the inner surface of the cylinder element 100 during spinning of the spinning assembly 20. The conical section 106 comprises a first, lower conical section 106a and a second, upper conical section 106b. Both sections increase in diameter in an upward direction, but the second, upper conical section 106b has a greater slant angle 108 than the first, lower conical section 106a.

The depressions 120 may be elongate, may extend vertically and may be parallel. The geometry, in particular a width 126 and/or a depth 127, of each depression 120 varies in a vertical 128 and horizontal 129 direction. The depth 127 of each depressions varies between 0.1-0.5 mm, in particular varies between 0.15-0.35 mm. Each depression 120 further comprises a lower narrow section 121a and a upper wider section 121b. The upper wider section 121b is wider than the lower narrow section 121a. Additionally, the depressions 120 are positioned at an equal distance from each other and form an array.

The cylinder element 100 is further movable to at least a first and a second coffee brewing position. The first coffee brewing position may be above the second coffee brewing position. The filtration gaps 124 between the cylinder element 100 and the upper seal 104 are wider or narrower in the first coffee brewing position than in the second coffee brewing position, allowing different filter areas for different coffee recipes.

The cylinder element 100 is also movable to a third, intermediate position 116 between the first, lower position 110 and second, upper position 112. An annular wiper seal 114 is positioned above the upper seal 104. The annular wiper seal 114 engages a lower edge 117 of the second, upper conical section 106b in the third, intermediate position 116. The wiper seal 114 blocks outgoing flow 118 of coffee from the brewing chamber 30 to build up pressure in the brewing chamber 30.

The cylinder element 100 is movable between the first, lower position 110 and the third, intermediate position 116. The upper seal 104 is able to engage the cylindrical wall 102 at different vertical heights. The varying geometry of each depression 120 in the vertical direction results in varying filtration areas of the filtration gaps 124 at different vertical heights. The plurality of different positions of the cylinder element 100 with respect to the chamber element 24 makes the device 10 suitable for brewing many different coffee recipes without making any adjustments to the device.

The annular wiper seal 114 has a smaller thickness 115 than the upper seal 104, allowing the annular wiper 114 seal to be less rigid than the upper seal 104. This enables the wiper seal 114 to follow the geometry of each depression 120 during an upward movement of the cylinder element 100 relative to the chamber element 24 in order to wipe the coffee residue from an inner surface 125 of each depression.

In operation, the method of brewing coffee comprises:
supplying ground coffee and hot water into the brewing chamber of the centrifugal coffee brewing device (10) when the cylinder element is in the first, lower position,
spinning the spinning assembly in order to brew coffee, wherein brewed coffee flows upwards through the filtration gaps during the spinning of the spinning assembly, while keeping the coffee residue in the brewing chamber,
moving the cylinder element from the first, lower position to the second, upper position,
spinning the chamber element in order to eject coffee residue,
moving the cylinder element from the second, upper position to the first, lower position.

The present machine may be configured to produce tea in addition to coffee.

### 5. Improved Hopper

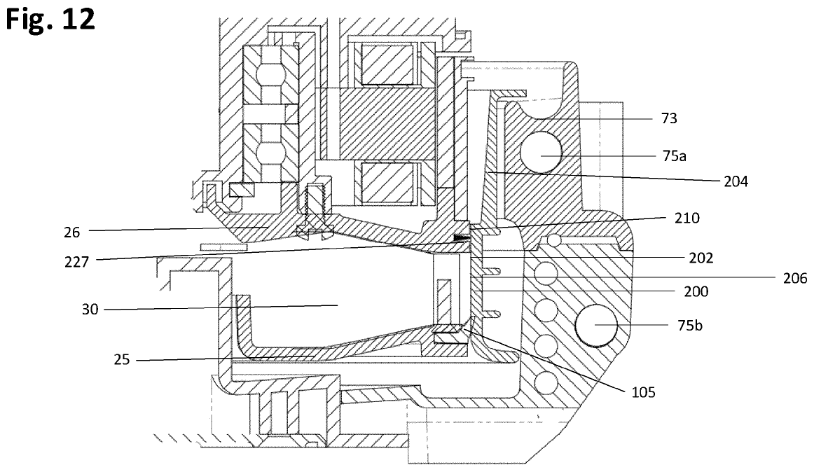

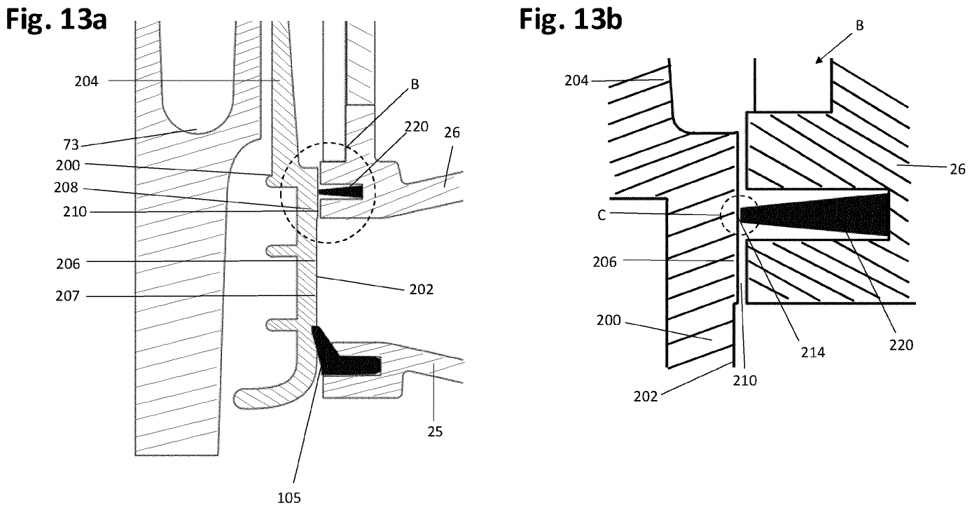

Turning to FIGS. 16-25, a hopper 300 for a coffee brewing device 10 is disclosed. The hopper comprises a bean compartment 302 configured for holding coffee beans.

The hopper further comprises a circumferential side wall 306 and a chute 308. A lower portion of the circumferential side wall 306 goes over in the chute 308

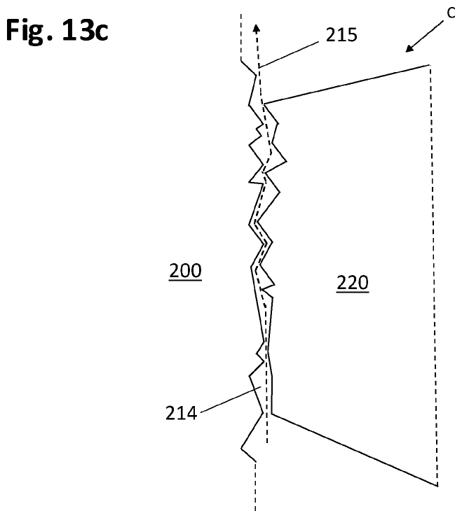

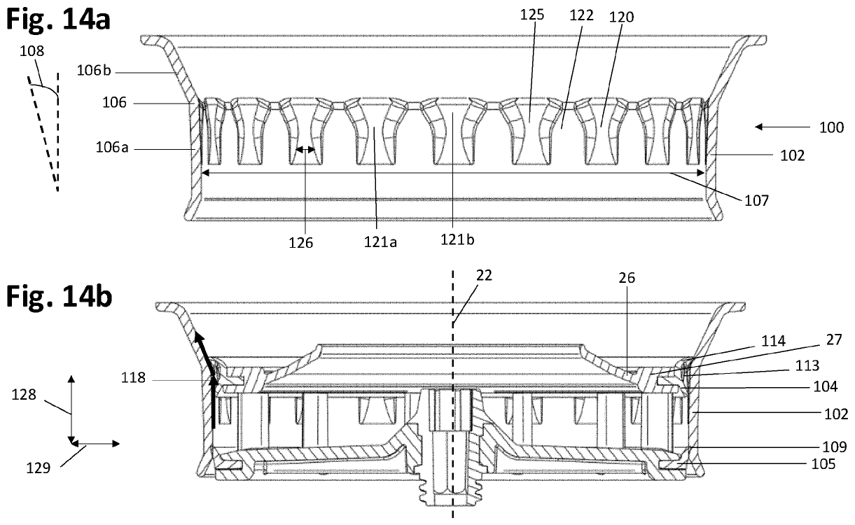

Turning to FIGS. 18 and 19, the hopper comprises an impeller 310 positioned at a lower portion of the hopper. The impeller comprises a hub 312 and blades 314 which project outwardly from the hub, and a surrounding wall 316 which surrounds the impeller and forms an impeller cavity 318 in which the impeller is located. A lower portion of the chute goes over in the surrounding wall. The impeller blades 314 are flexible and are in particular made of rubber. The tips of the impeller blades are chamfered at the upper side. Impeller compartments 370 are provided between the impeller blades 314. In this embodiment there are seven impeller compartments. There are seven impeller blades. Each impeller compartment spans a circumferential angle of 360/7=51.4 degrees.

When seen in top view, the hub has a hub diameter D1 and the surrounding wall defines a surrounding wall diameter D2. The hub diameter D1 may be at least 40 percent, and in some cases at least 50 percent of the surrounding wall diameter D2. The hub diameter D1 is at least 30 mm, in particular at least 40 mm. A difference between the hub diameter (D1) and the surrounding wall diameter (D2) is at least 40 mm.

The blades have outer tips 320 which when seen in top view define a blade diameter D3 of the impeller, wherein the blade diameter is at least 75 mm, more in particular at least 80 mm. In case of an uneven number of blades such as shown in FIG. 19 the blade diameter is defined by a contour of the blade tips 320 during rotation of the impeller.

The hopper 300 further comprises a brewer coupling 355 for coupling the hopper with the coffee brewing device. The coupling is a bayonet coupling. The coffee brewing device comprises a mating hopper coupling 356, in particular a bayonet coupling, for coupling the hopper to the coffee brewing device. The hopper coupling 356 is configured to first allow the hopper to engage the coupling, followed by a rotation of the hopper about a vertical axis to secure the hopper to the coffee brewing device.

The coffee brewing device comprises a second holding member 346 configured to engage a first holding member 342 of a rotatable bottom valve member of the hopper. The rotatable bottom valve member is rotatable relative to the rest of the hopper, wherein the second holding member is configured to hold the rotatable bottom valve member during the rotation of the hopper about the vertical axis.

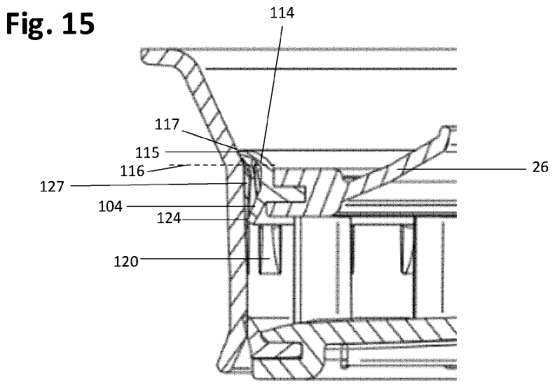

Turning to FIG. 20, the hopper 300 is shown with an upper part of the coffee brewing device. The chute 308 tapers outwardly in an upward direction. The chute 308 has a chute diameter D4 which increases in an upward direction. The chute diameter D4 at a lowest part of the chute is at least 70 percent of an inner diameter D5 of the circumferential side wall.

The hopper further comprises a bottom wall 330 and a bean exit 332 in the bottom wall. When seen in top view, the bean exit is located radially within the blade diameter D3, during a rotation of the impeller, the impeller blades move over the bean exit and the beans drop through the bean exit under the influence of gravity. The bean exit may have about a same size and/or shape as an impeller compartment 370.

The bottom wall 330 is fixed and called a fixed bottom wall. The hopper further comprises a rotatable bottom valve member 336 which is positioned above the fixed bottom wall. The rotatable bottom valve member is rotatable about a central axis 338 relative to the fixed bottom wall and relative to the rest of the hopper 300. The fixed bottom wall comprises a fixed bean exit 332. The rotatable bottom valve member may comprise a rotatable bean exit 340. The rotatable bottom valve member 336 comprises a first holding member 342 configured to engage a second holding member of the coffee brewing device. The fixed bottom wall comprises a curved slot 345 through which the second holding member penetrates and engages the first holding member. The second holding member 346 is a pin in this embodiment, but different configurations are possible.

A drive shaft and a gearbox 380 of an impeller drive assembly 350 extends into a drive cavity 351 of the hopper. This saves height and allows a lower and therefore more compact coffee brewing device. The electromotor 381 of the impeller drive assembly is mounted directly below the hopper. The impeller drive assembly is configured for rotating the impeller at a rotational speed of less than 25 rpm, in particular less than 20 rpm, more in particular about 15 rpm.

The surrounding wall 316 which surrounds the impeller is lower than the impeller blades 314. When seen in side view, the impeller blades 314 extend to above a lowest part of the chute 308.

The hopper further comprises a roof member 349 which is positioned above the impeller and vertically above the bean exit. The roof member 349 is in particular connected to the side wall 306 of the hopper and extends over a horizontal distance inward from the side wall. The roof member comprises a leading edge 352 which when seen in top view is oriented at a sharp angle (α) relative to the blade which is directly underneath the leading edge, such that the leading edge pushes any coffee bean which hits the leading edge during a rotation of the impeller in an outward direction. The roof member 349 is large enough to cover two impeller compartments 370. In other words, in top view the roof member extends over a circumferential angle of at least twice the circumferential angle of an impeller compartment 370, which for seven blades is about 102 degrees.

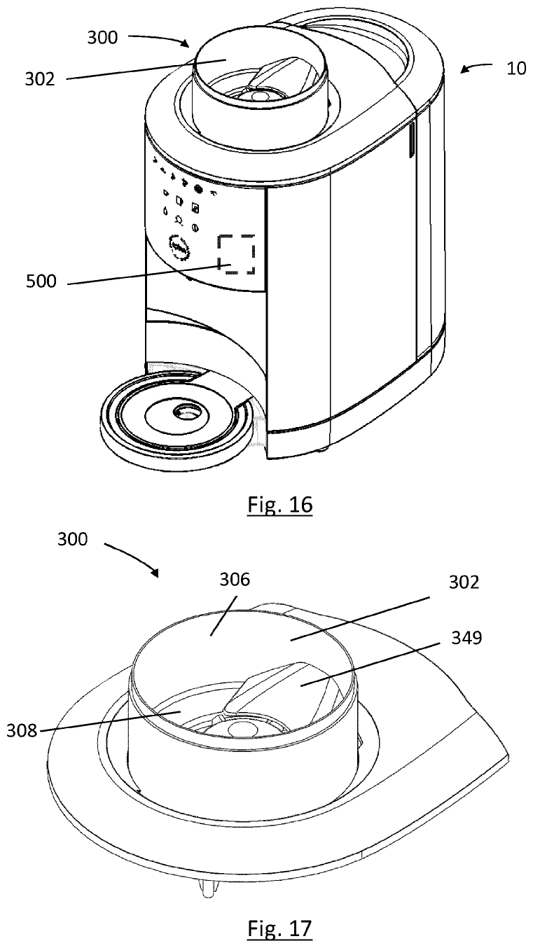

Turning to FIG. 21 a bottom view of the coffee brewing device 10 is shown with partial cut-away. The coffee brewing device comprises at least one weight sensor 358 and in particular a plurality of weight sensors 358 for weighing the hopper including the coffee beans in the hopper. Preferably there are four weight sensors. The coffee brewing device comprises a support platform 360 for the hopper 300. When seen in top view or bottom view, the weight sensors are located at a circumference of the support platform.

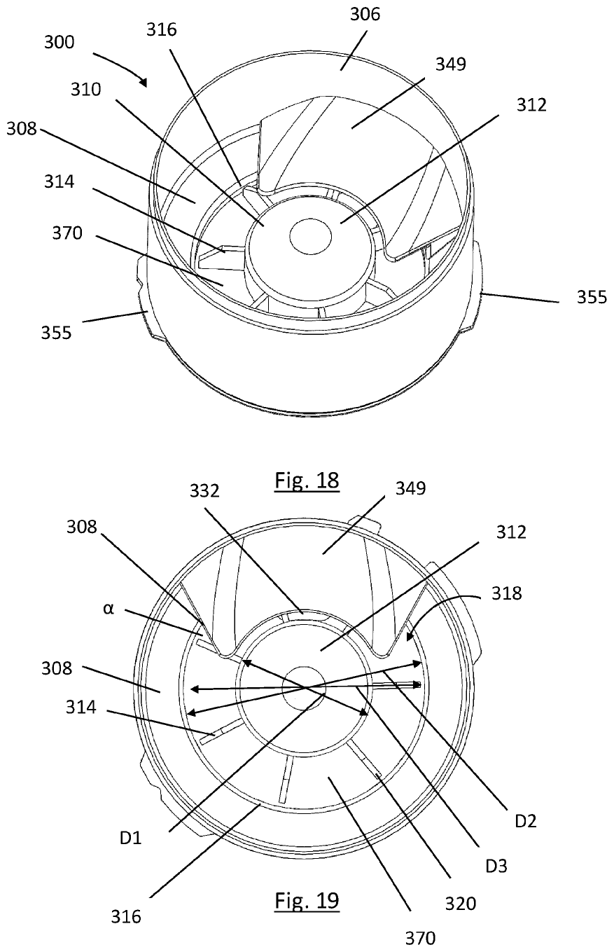

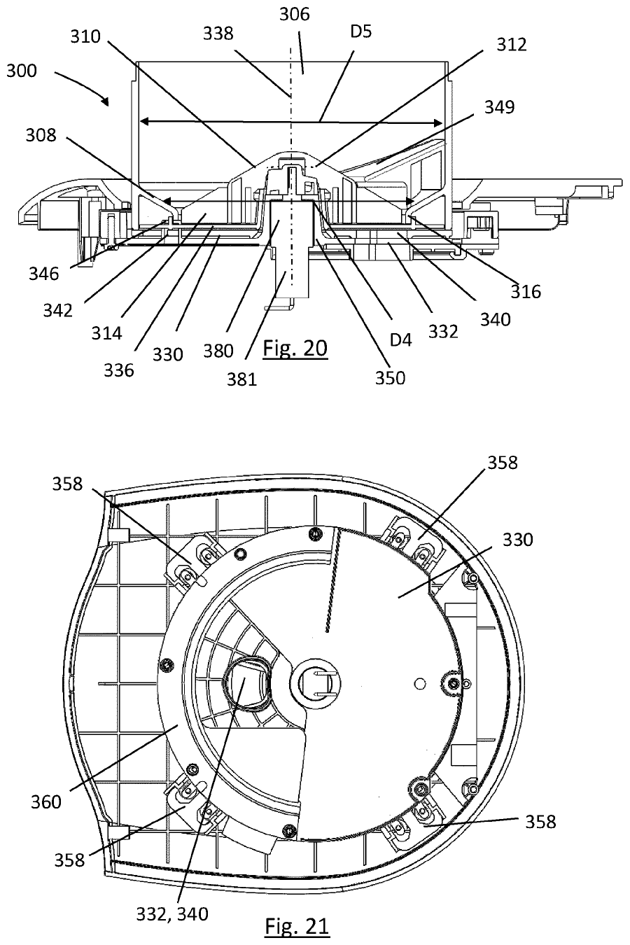

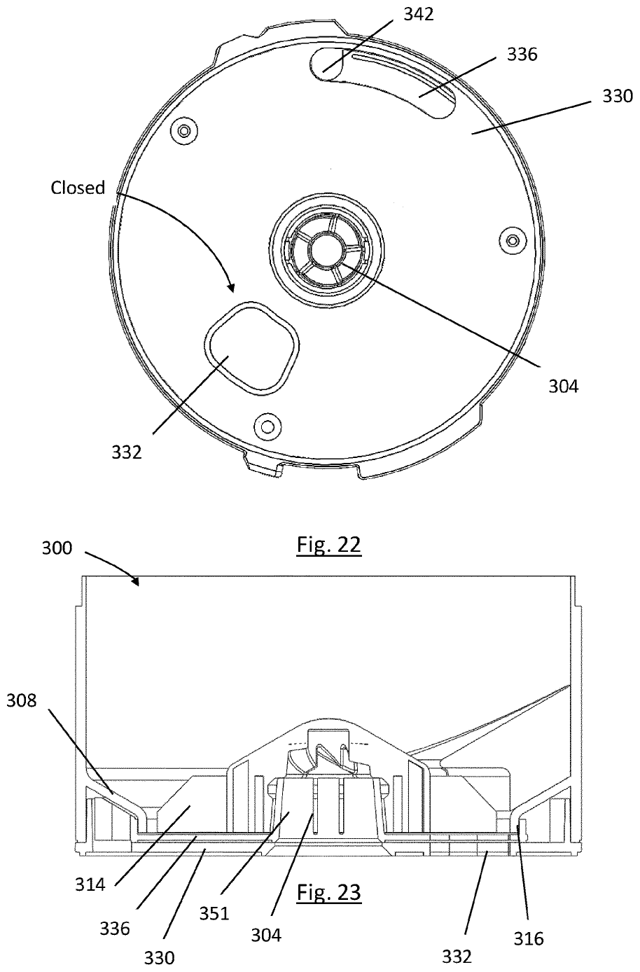

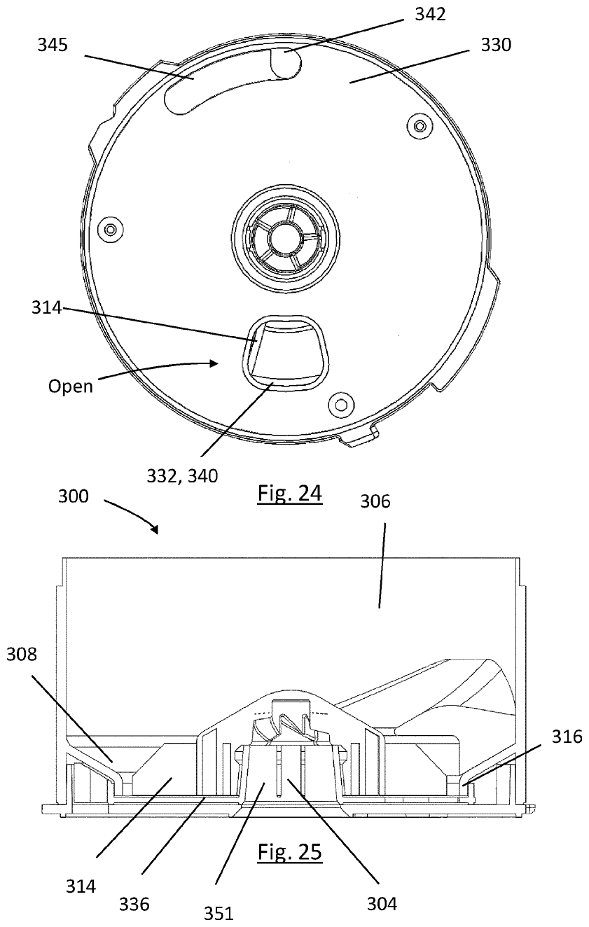

Turning to FIGS. 22-25, the hopper 300 is configured to be engaged with the coffee brewing device 10. The first holding member then engages with the second holding member. The hopper is subsequently rotated about a vertical axis 338. During said rotation, the first and second holding member hold the rotatable bottom valve member 336 while the rest of the hopper 300 is rotated relative to said rotatable bottom valve member 336. During said rotation the fixed bean exit 332 rotates together with the rest of the hopper 300 from a first, closed position as shown in FIGS. 22, 23 to a second, open position in which the fixed bean exit is open. In case rotatable bottom valve member comprises a rotatable bean exit, the fixed bean exit is aligned with the rotatable bean exit as shown in FIGS. 24 and 25. In the non-aligned position, the bean exit is closed and in the aligned position the bean exit is open. A spring or other biasing member may be present in the hopper to bias the rotatable bottom valve member 336 to the closed position. The rotatable bottom valve member may also be smaller, i.e. be an ‘ordinary’ valve member without a rotatable bean exit.

The hopper further comprises a drive coupling 304. The drive coupling is configured to be coupled with a shaft of an impeller drive assembly 350 of the coffee brewing device, wherein the drive coupling is connected to the impeller.

The coffee brewing device comprises a grinder 40 and a control unit 500 which is configured for performing the following sequence of steps:
a) weighing the hopper including the coffee beans for a first time with the weight sensor(s) 358,
b) rotating the impeller 310 for a first time period, thereby feeding coffee beans from the hopper 300 to the grinder 40,
c) weighing the hopper 300 including the coffee beans for a second time to determine a weight difference,
d) evaluating the weight difference and when the weight difference is smaller than a target weight difference, rotating the impeller 310 for a second time period to feed additional coffee beans to the grinder.

The control unit may comprise a calibration module configured for using the weight difference determined in the sequence of steps for calibrating the first time period and/or the rotational speed of the impeller for a next cup of coffee, wherein when the weight difference is above a first threshold value, the first time period or rotational speed is increased for a next cup, and when the weight difference is below a second threshold value, the first time period or rotational speed is reduced for a next cup.

The control unit 500 may be configured to stop the grinder during the weight measurement. The control unit 500 may be configured to rotate the impeller and the grinder simultaneously. The control unit 500 may be configured to vary the grind size of the grinding during the dosing, i.e. during the grinding, in order to form a layered coffee cake in the brewing chamber.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising i.e., open language, not excluding other elements or steps.

Any reference signs in the claims should not be construed as limiting the scope of the claims or the invention. It will be recognized that a specific embodiment as claimed may not achieve all of the stated objects.

If certain features are recited in mutually different dependent claims, a combination of these measures may still be used to advantage.

White lines between text paragraphs in the text above indicate that the technical features presented in the paragraph may be considered independent from technical features discussed in a preceding paragraph or in a subsequent paragraph.

1. Centrifugal coffee brewing device (10) comprising:
a spinning assembly (20) which is rotatable about a main axis (22) for centrifuging coffee, the spinning assembly comprising a brewing chamber (30),
a coffee bean grinder (40) comprising a first burr (42) and a second burr (44), wherein the first and second burr are rotatable relative to one another about a grinder axis (46),
wherein the main axis and the grinder axis are coaxial.

2. Centrifugal coffee brewing device according to claim 1, comprising a drive assembly (50) configured for rotating the spinning assembly about the main axis, wherein the drive assembly comprises a stator (52) and a rotor (54) configured to rotate about a rotor axis (56), wherein the rotor axis is coaxial with the main axis and the grinder axis.

3. Centrifugal coffee brewing device according to the preceding claim, wherein the second burr is connected to the spinning assembly and driven by the drive assembly via the spinning assembly.

4. Centrifugal coffee brewing device according to any of the preceding claims, wherein the spinning assembly comprises:
a chamber element (24) comprising a bottom wall (25) and a roof portion (26),
a cylinder element (100),
wherein the chamber element and the cylinder element form the brewing chamber, and wherein the second burr is connected to the chamber element and rotates with the chamber element.

5. Centrifugal coffee brewing device according to any of claims 2-4, wherein the drive assembly comprises a direct drive electromotor, the direct drive electromotor comprising multiple coils (55) which are positioned in a circular arrangement (56) on the stator, each coil having a main axis which is oriented radially, and wherein a plurality of magnets (57) are positioned in a circular arrangement (58) on the rotor.

6. Centrifugal coffee brewing device according to any of claims 2-5, wherein the rotor is connected to the spinning assembly, and in particular to a roof portion of the chamber element.

7. Centrifugal coffee brewing device according to any of the preceding claims, wherein the coffee bean grinder is positioned directly above the spinning assembly.

8. Centrifugal coffee brewing device according to any of the preceding claims 2-7, wherein at least a part of the coffee bean grinder is positioned at a same vertical level (59) as the drive assembly.

9. Centrifugal coffee brewing device according to any of claims 2-8, wherein the stator is positioned within the rotor and the rotor extends around the stator, wherein in particular the coils are positioned within the magnets.

10. Centrifugal coffee brewing device according to any of the preceding claims, wherein the second, rotatable burr is positioned within the first burr.

11. Centrifugal coffee brewing device according to any of claims 4-10, comprising an axle (28) which extends downward from the second burr and is connected to the roof portion of the chamber element, and is driven by the roof portion of the chamber element.

12. Centrifugal coffee brewing device according to any of the preceding claims, wherein the drive assembly performs a further function of increasing the temperature of the coffee bean grinder to reduce or prevent condensation in the coffee bean grinder, wherein in particular the temperature of the coffee bean grinder is increased using radiative and/or conductive heat transfer from the drive assembly.

13. Centrifugal coffee brewing device according to any of the preceding claims, wherein the drive assembly drives both the spinning assembly and the coffee bean grinder, and wherein the centrifugal coffee brewing device does not comprise a separate grinder drive for rotating the first and second burr relative to one another.

14. Centrifugal coffee brewing device according to any of the preceding claims, wherein the spinning assembly comprises at least one brewer bearing (29) which provides radial and axial support to the spinning assembly, the rotor of the drive assembly and the second burr, and wherein the stator extends around the brewer bearing.

15. Centrifugal coffee brewing device according to any of the preceding claims, wherein the chamber element and the cylinder element are movable relative to each other in the axial direction, wherein in particular the chamber element is fixed in the axial direction and the cylinder element is movable in the axial direction.

16. Centrifugal coffee brewing device according to any of the preceding claims, wherein the first burr and the second burr are movable relative to each other in the axial direction, wherein in particular the second burr is fixed in the axial direction and the first burr is movable in the axial direction.

17. Centrifugal coffee brewing device according to any of the preceding claims, wherein the spinning assembly has a diameter of more than 110 mm, in particular between 120 and 130 mm.

18. Method of brewing coffee, the method comprising:
providing coffee beans to the coffee bean grinder of the centrifugal coffee brewing device (10) according to any of the preceding claims,
spinning the spinning assembly with the drive assembly, thereby rotating the first and second burr relative to one another in order to grind the coffee beans,
supplying hot water in the brewing chamber,
spinning the spinning assembly with the drive assembly in order to brew coffee.

19. Centrifugal coffee brewing device (10) comprising:
a spinning assembly (20) which is rotatable about a main axis (22), the spinning assembly comprising a brewing chamber (30) for brewing coffee,
a pump (60),
a heater-gutter device (70) comprising a heater (79) and a gutter (73), the heater-gutter device comprising:
an annular device (71), the annular device defining a gutter wall (72) which defines the gutter via which the brewed coffee which is expelled from the spinning assembly travels to a spout (74),
a helicoidal duct (62) located in the annular device and extending about the main axis, wherein the helicoidal duct comprises multiple windings located at different vertical levels, the helicoidal duct comprising an inlet (64) and an outlet (65), wherein the inlet is connected to a lower winding (67) and the outlet is connected to an upper winding (63),
the heater comprising at least one electric heating element (75) located within the annular device, and extending about the main axis, wherein the at least one electric heating element is configured for:
1) heating the gutter wall for reducing temperature losses of the brewed coffee, and
2) heating water which travels through the helicoidal duct prior to the water being introduced in the brewing chamber,
wherein the pump is configured to circulate water through the internal helicoidal duct from the inlet (64) to the outlet (65) in an upwardly spiraling direction (66).

20. Centrifugal coffee brewing device according to the preceding claim, wherein the heater comprises at least two electric heating elements (75), namely a first heating element (77a) and a second heating element (77b) which are independently controllable, wherein the first heating element comprises a first heating winding (75a) and the second heating element comprises a second heating winding (75b), wherein in particular each heating element comprises a separate power supply (76).

21. Centrifugal coffee brewing device according to the preceding claim, wherein the first heating element is connected to a first power supply (76a) having a range of 200-600 Watt and the second heating element is connected to a second power supply (76b) of 700-2000 Watt.

22. Centrifugal coffee brewing device according to any of the two preceding claims, wherein the first heating element is located above the second heating element.

23. Centrifugal coffee brewing device according to any of claims 19-22, wherein the annular device comprises at least two annular bodies, an upper annular body (132) and a lower annular body (133), wherein the upper annular body is positioned above the lower annular body.

24. Centrifugal coffee brewing device according to the preceding claim, wherein the upper annular body defines the gutter wall.

25. Centrifugal coffee brewing device according to any of the two preceding claims, wherein the helicoidal duct is located in the lower annular body.

26. Centrifugal coffee brewing device according to any of claims 19-25, wherein at least one heating element is positioned directly below the gutter.

27. Centrifugal coffee brewing device according to any of claims 19-26, wherein the upper, downstream winding of the helicoidal duct is positioned lower than the uppermost heating element and further away from the gutter than the uppermost heating element.

28. Centrifugal coffee brewing device according to any of claims 19-27, wherein the lower, upstream winding of the helicoidal duct is positioned lower than the lowermost heating element.

29. Centrifugal coffee brewing device according to claims 19-28, wherein the helicoidal duct comprises at least three windings, and more in particular four windings.

30. Method of brewing coffee, the method comprising:
providing ground coffee in the centrifugal coffee brewing device (10) according to any of claims 19-29,
circulating relatively cold water through the helicoidal duct of the heater-gutter device with the pump and heating the water with the heater,
supplying the hot water in the brewing chamber,
spinning the spinning assembly in order to brew coffee,
wherein the heater heats the relatively cold water in the helicoidal duct, the gutter, and the brewed coffee in the gutter, and
wherein the cold water circulates through the helicoidal duct in an upwardly spiraling direction, providing hot water at the outlet of the helicoidal duct.

31. Centrifugal coffee brewing device (10) comprising:
a spinning assembly (20) which is rotatable about a main axis (22), the spinning assembly comprising a brewing chamber (30), wherein the spinning assembly comprises a bottom wall (38) having a central aperture (37),
a hot water supply assembly (90) for supplying hot water into the brewing chamber, the hot water supply assembly comprising:
a spraying element (92) configured to spray the hot water into the brewing chamber, wherein the spraying element comprises at least one nozzle (94),
a supply channel (96) which is configured to supply hot water to the spraying element, the supply channel comprising a first section (98) and a second section (99),
wherein the first section extends below the brewing chamber, and wherein the second section extends in an upward direction from the first section and extends through the central aperture in the bottom wall (38) of the spinning assembly.

32. Centrifugal coffee brewing device according to the preceding claim, wherein the spinning assembly comprises an upstanding wall portion (39) which extends upward from the bottom wall and which defines the central aperture, wherein the hot water supply assembly is configured to supply the hot water into the brewing chamber over the upstanding wall portion.

33. Centrifugal coffee brewing device according to any of the two preceding claims, wherein the brewing chamber has an annular shape.

34. Centrifugal coffee brewing device according to any of the two preceding claims, wherein the nozzle is configured to spray hot water over a horizontal distance (95), and wherein the spraying element in particular comprises multiple nozzles (94), wherein the multiple nozzles are positioned next to each other, and in particular at a horizontal distance from one another.

35. Centrifugal coffee brewing device according the preceding claim, wherein the spraying element comprises at least one nozzle, in particular multiple nozzles, wherein the multiple nozzles are configured to spray hot water at different angles (97), allowing an evenly distributed supply of hot water onto a coffee bed (31) in the brewing chamber.

36. Centrifugal coffee brewing device according to any of claims 31-35, wherein the spraying element is positioned eccentrically from the main axis.

37. Method of brewing coffee, the method comprising:
a) providing ground coffee in the centrifugal coffee brewing device (10) according to any of claims 31-36,
b) providing hot water to the spraying element through the supply channel and spraying the hot water into the brewing chamber,
c) spinning the spinning assembly in order to brew coffee.

38. Method of claim 37, wherein the hot water is supplied into the brewing chamber over the upstanding wall portion.

39. Centrifugal coffee brewing device (10) comprising a spinning assembly (20) which is rotatable about a main axis (22), the spinning assembly comprising:
a) a chamber element (24) comprising a bottom wall (25) and a roof portion (26),
b) a cylinder element (100; 200) comprising a cylindrical wall (102; 202),
wherein the roof portion comprises a peripheral edge (27),
wherein the chamber element and the cylinder element form a brewing chamber (30),
wherein the cylinder element and the chamber element are movable relative to one another between:
a first, lower position (110) of the cylinder element relative to the chamber element in which the cylinder element forms a circumference of the brewing chamber and in which the spinning assembly has a brewing configuration, and
a second, upper position (112) of the cylinder element relative to the chamber element in which the circumference of the brewing chamber is open, and in which second position coffee residue can be ejected by spinning the chamber element,
wherein the peripheral edge and the cylindrical wall define at least one aperture (113; 210) between them when the cylinder element is in the first, lower position,
wherein a filtration gap (124; 212) is formed by the at least one aperture between the peripheral edge and the cylindrical wall, and
wherein the filtration gap allows brewed coffee to flow upwards through the filtration gap during the spinning of the spinning assembly while keeping the coffee residue in the brewing chamber.

40. Centrifugal coffee brewing device according to the preceding claim, wherein the cylinder element comprises a conical section (106; 204) which increases in diameter (107) in an upward direction, wherein the conical shape forces the brewed coffee to travel upwards along the inner surface of the cylinder element outside the brewing chamber during spinning of the spinning assembly.

41. Centrifugal coffee brewing device according to claims 39 or 40, wherein the size of the filtration gap and the rotational speed of the spinning assembly determine the pressure in the brewing chamber, and wherein different brewing chamber pressures allow brewing of different coffee recipes.

42. Centrifugal coffee brewing device according to any of claims 39-41, wherein the cylinder element does not comprise holes which extend through the cylindrical wall from the inside to the outside.

43. Centrifugal coffee brewing device according to any of claims 39-42, wherein the spinning assembly comprises an annular wiper seal (114) which is connected to the roof portion, wherein the annular wiper seal is configured to wipe coffee residue from the cylinder element when the cylinder element is moved from the first, lower position to the second, upper position.

44. Centrifugal coffee brewing device according to any of claims 39-43, wherein the cylindrical wall extends above the roof portion when the cylinder element is in the first, lower position.

45. Centrifugal coffee brewing device according to any of claims 39-44, wherein the at least one aperture is an annular aperture (210).

46. Centrifugal coffee brewing device according to any of claims 39-45, wherein the cylinder element comprises a vertical section (206).

47. Centrifugal coffee brewing device according to claims 45 or 46, wherein the vertical section of the cylinder element comprises:
a first, lower vertical section (207),
a second, upper vertical section (208),
wherein the second, upper vertical section is located inwardly from the lower, vertical section of the cylinder element, wherein the inwardly extending upper, vertical section and the peripheral edge define the annular aperture.

48. Centrifugal coffee brewing device according to any of claims 39-47, wherein the distance between the cylinder wall and the peripheral edge of the roof portion is 0-0.5 mm, in particular 0-0.25 mm.

49. Centrifugal coffee brewing device according to any of claims 39-48, comprising a filter seal (220) which extends outwardly from a peripheral edge (227) of the roof portion, wherein the filter seal and the upper, vertical section of the cylinder element define the at least one filtration gap (214).

50. Centrifugal coffee brewing device according to the preceding claim, wherein the filter seal touches the upper, vertical section of the cylinder element, wherein the surface roughness of the filter seal and/or the surface roughness of the cylinder element results in multiple filtration gaps (214) to allow brewed coffee to flow upwards (215) through the filtration gaps during the spinning of the spinning assembly while keeping the coffee residue in the brewing chamber.

51. Centrifugal coffee brewing device according to claims 49 or 50, wherein the filter seal is not fixed to the peripheral edge and is configured to move between an open state and a closed state, wherein in the open state the at least one filtration gap is open and in the closed state the at least one filtration gap is closed.

52. Centrifugal coffee brewing device according to any of claims 49-51, wherein the filter seal is forced outwardly by the centrifugal force during spinning of the spinning assembly.

53. Centrifugal coffee brewing device according to the preceding claim, wherein the rotational speed of the spinning assembly determines the degree of sealing of the filter seal, wherein an increment of the rotational speed decreases the amount of filtration gaps, and wherein a decrement of the rotational speed increases the amount of filtration gaps.

54. Centrifugal coffee brewing device according to any of claims 49-53, wherein the annular wiper seal is positioned above the filter seal.

55. Centrifugal coffee brewing device according to any of claims 39-54, comprising an upper seal (104) which extends outwardly from a peripheral edge (27) of the roof portion.

56. Centrifugal coffee brewing device according to any of claims 39-55, wherein the cylindrical wall has multiple depressions (120) on an inner side thereof.

57. Centrifugal coffee brewing device according to the preceding claim, wherein in the first, lower position the depressions are positioned at a level of the upper seal and the upper seal engages the inner surface of the cylindrical wall in wall areas (122) outside the depressions but remains at a distance from the cylindrical wall at the depressions, wherein filtration gaps (124) are formed between the upper seal and the cylindrical wall at the depressions.

58. Centrifugal coffee brewing device according to claims 56 or 57, wherein the depressions are elongate.

59. Centrifugal coffee brewing device to any of claims 56-58, wherein the depressions extend vertically.

60. Centrifugal coffee brewing device to any of claims 56-59, wherein the depressions are parallel.

61. Centrifugal coffee brewing device to any of claims 39-60, wherein the cylinder element comprises:
a first, lower conical section (106a) which increases in diameter in an upward direction,
a second, upper conical section (106b) which increases in diameter in an upward direction,
wherein the second, upper conical section has a greater slant angle (108) than the first, lower conical section.

62. Centrifugal coffee brewing device according to any claims 56-61, wherein the geometry, in particular a width (126) and/or a depth (127), of each depression varies in a vertical (128) and/or horizontal (129) direction.

63. Centrifugal coffee brewing device according to any claims 56-62, wherein each depression comprises a lower narrow section (121a) and an upper wider section (121b) which is wider than the lower narrow section.

64. Centrifugal coffee brewing device according to any of claims 39-63, wherein the cylinder element is movable to at least a first and a second coffee brewing position, wherein the first coffee brewing position is above the second coffee brewing position, wherein the filtration gap or filtration gaps between the cylinder element and the upper seal is/are wider or narrower in the first coffee brewing position than in the second coffee brewing position, allowing different filter areas for different coffee recipes.

65. Centrifugal coffee brewing device according to any of claims 56-64, wherein the depth of each depression varies in the vertical and horizontal directions and more in particular varies between 0.1-0.5 mm, in particular 0.15-0.35 mm.

66. Centrifugal coffee brewing device according to any of claims 61-65, wherein the cylinder element is movable to a third, intermediate position (116) between the first, lower position and second, upper position, wherein the annular wiper seal engages a lower edge (117) of the second, upper conical section in the third, intermediate position to block an outgoing flow (118) of coffee from the brewing chamber and to build up pressure in the brewing chamber.

67. Centrifugal coffee brewing device according to any of claims 56-66, wherein the cylinder element is movable between the first, lower position and the third, intermediate position, wherein the upper seal is able to engage the cylindrical wall at different vertical heights, and wherein the varying geometry of each depression in the vertical direction results in varying filtration areas of the filtration gaps at said different vertical heights.

68. Centrifugal coffee brewing device according to any of claims 56-67, wherein the depressions are positioned at an equal distance from each other and form an array.

69. Centrifugal coffee brewing device according to any of claims 55-68, wherein the annular wiper seal is positioned above the upper seal.

70. Centrifugal coffee brewing device according to any of claims 56-69, wherein the annular wiper seal has a smaller thickness (115) than the upper seal, allowing the annular wiper seal to be less rigid than the upper seal and to follow the geometry of each depression during an upward movement of the cylinder element relative to the chamber element in order to wipe coffee residue from an inner surface (125) of each depression.

71. Centrifugal coffee brewing device according to any of claims 55-70, wherein the filter seal and upper seal are configured to maintain concentricity between the chamber element and the cylinder element.

72. Method of brewing coffee, the method comprising:
supplying ground coffee and hot water into the brewing chamber of the centrifugal coffee brewing device (10) according to any of claims 39-71 when the cylinder element is in the first, lower position,
spinning the spinning assembly in order to brew coffee, wherein brewed coffee flows upwards through the at least one filtration gap during the spinning of the spinning assembly, while keeping the coffee residue in the brewing chamber,
moving the cylinder element from the first, lower position to the second, upper position,
spinning the chamber element in order to eject coffee residue,
moving the cylinder element from the second, upper position to the first, lower position.

73. Hopper for a coffee brewing device, wherein the hopper comprises:
a bean compartment ( ) configured for holding coffee beans,
a brewer coupling ( ) for coupling the hopper with the coffee brewing device,
an impeller ( ) positioned at a lower portion of the hopper, wherein the impeller comprises a hub ( ) and blades ( ) which project outwardly from the hub, and
a surrounding wall ( ) which surrounds the impeller and forms an impeller cavity ( ) in which the impeller is located.

74. Hopper according to the preceding claim, wherein when seen in top view the hub has a hub diameter (D1) and the surrounding wall defines a surrounding wall diameter (D2), wherein the hub diameter (D1) is at least 40 percent, in particular at least 50 percent of the surrounding wall diameter (D2).

75. Hopper according to the preceding claim, wherein the hub diameter is at least 30 mm, in particular at least 40 mm.

76. Hopper according to any of claims 73 to the present claim, wherein a difference between the hub diameter (D1) and the surrounding wall diameter (D2) is at least 40 mm.

77. Hopper according to any of claims 73 to the present claim, wherein the blades have outer tips which when seen in top view define a blade diameter of the impeller, wherein the blade diameter is at least 75 mm, more in particular at least 80 mm.

78. Hopper according to any of claims 73 to the present claim, wherein the impeller has more than five blades and in particular seven blades. It was found that this makes accurate dosing, i.e. volumetric dosing, easier.

79. Hopper according to any of claims 73 to the present claim, further comprising a circumferential side wall and a chute, wherein a lower portion of the circumferential side wall goes over in the chute and a lower portion of the chute goes over in the surrounding wall.

80. Hopper according to the preceding claim, wherein the chute tapers outwardly in an upward direction, wherein the chute has a chute diameter which increases in an upward direction, and wherein the chute diameter at a lowest part of the chute is at least 70 percent of an inner diameter of the circumferential side wall.

81. Hopper according to any of claims 73 to the present claim, wherein the hopper further comprises a bottom wall and a bean exit in the bottom wall, wherein when seen in top view the bean exit is located radially within the blade diameter, wherein during a rotation of the impeller, the impeller blades move over the bean exit and the beans drop through the bean exit.

82. Hopper according to any of claims 73 to the present claim, wherein the hopper comprises a fixed bottom wall and a rotatable bottom valve member, the rotatable bottom valve member being rotatable relative to the fixed bottom wall, wherein the fixed bottom wall comprises a fixed bean exit, wherein the rotatable bottom valve member comprises a first holding member configured to engage a second holding member of the coffee brewing device, wherein the hopper is configured to be engaged with the coffee brewing device and to subsequently be rotated about a vertical axis ( ), wherein during said rotation the first and second holding member hold the rotatable bottom valve member while the rest of the hopper is rotated, wherein during said rotation the fixed bean exit rotates together with the rest of the hopper relative to the rotatable bottom valve member between a closed position in which the valve member closes the fixed bean exit and an open position in which the valve member does not close off the fixed bean exit.

83. Hopper according to any of claims 73 to the present claim, further comprising a drive coupling on a bottom side of the hopper, wherein the drive coupling is configured to be coupled with an impeller drive assembly of the coffee brewing device, wherein the drive coupling is connected to the impeller.

84. Hopper according to any of claims 73 to the present claim, further comprising a roof member which is positioned above the impeller and vertically above the bean exit, wherein the roof member is in particular connected to a side wall of the hopper and extends over a horizontal distance inward from the side wall.

85. Hopper according to the preceding claim, wherein the roof member extends over a circumferential angle of at least twice the circumferential angle of an impeller compartment.

86. Hopper according to the preceding claim, wherein the roof member comprises a leading edge which when seen in top view is oriented at a sharp angle (α) relative to the blade which is directly underneath the leading edge, such that the leading edge pushes any coffee bean which hits the leading edge during a rotation of the impeller in an outward direction.

87. Hopper according to any of claims 73 to the present claim, wherein the impeller blades are flexible and are in particular made of rubber.

88. Hopper according to any of claims 73 to the present claim, wherein the surrounding wall which surrounds the impeller is lower than the impeller blades, and wherein when seen in side view the impeller blades extend to above a lowest part of the chute.

89. Coffee brewing device or grinder device configured to receive the hopper of any of claims 73 to the present claim.

90. Coffee brewing device or grinder device, comprising an impeller drive assembly (350), wherein the impeller drive assembly is configured for rotating the impeller at a rotational speed of less than 25 rpm, in particular less than 20 rpm, more in particular about 15 rpm.

91. Coffee brewing device or grinder device according to any of claims 86 to the present claim, further comprising at least one weight sensor and in particular a plurality of weight sensors for weighing the hopper including the coffee beans in the hopper.

92. Coffee brewing device or grinder device according to the preceding claim, comprising a support platform for the hopper, wherein when seen in top view the weight sensors are located at a circumference of the support platform.

93. Coffee brewing device or grinder device according to any of the two preceding claims, the coffee brewing device comprising a grinder and a control unit which is configured for performing the following sequence of steps:
a) weighing the hopper including the coffee beans for a first time with the weight sensor(s),
b) rotating the impeller for a first time period, thereby feeding coffee beans from the hopper to the grinder,
c) weighing the hopper including the coffee beans for a second time to determine a weight difference,
d) evaluating the weight difference and when the weight difference is smaller than a target weight difference, rotating the impeller for a second time period to feed additional coffee beans to the grinder.

94. Coffee brewing device or grinder device according to the preceding claim, wherein the control unit comprises a calibration module configured for using the weight difference determined in the sequence of steps for calibrating the first time period for a next cup of coffee, wherein when the weight difference is above a first threshold value, the first time period or rotational speed is increased, and when the weight difference is below a second threshold value, the first time period or rotational speed is reduced.

95. Coffee brewing device or grinder device according to any of the two preceding claims, wherein the control unit is configured to stop the grinder during the weight measurement.

96. Coffee brewing device or grinder device according to any of claims 86 to the present claim, wherein the coffee brewing device comprising a hopper coupling, in particular a bayonet coupling, for coupling the hopper to the coffee brewing device, wherein the coupling is configured to first allow the hopper to engage the coupling, followed by a rotation of the hopper about a vertical axis to secure the hopper to the coffee brewing device, wherein the coffee brewing device comprises a second holding member configured to engage a first holding member of a rotatable bottom valve member of the hopper, the rotatable bottom valve member being rotatable relative to the rest of the hopper, wherein the second holding member is configured to hold the rotatable bottom valve member during the rotation of the hopper about the vertical axis.

97. Coffee brewing device or grinder device according to any of claims 86 to the present claim, wherein the control unit is configured to rotate the impeller and the grinder simultaneously.

98. Coffee brewing device or grinder device according to any of claims 86 to the present claim, wherein the control unit is configured to vary the grind size of the grinding during the dosing.

99. Combination of a hopper according to any of claims 73-85 and a coffee brewing device or grinder device according to any of claims 86-95.

100. Coffee bean grinder device comprising:
a coffee bean grinder (40) comprising a first burr (42) and a second burr (44), wherein the first and second burr are rotatable relative to one another about a grinder axis (46),
a drive assembly (50) configured for rotating the coffee bean grinder about the grinder axis, wherein the drive assembly comprises a stator (52) and a rotor (54) configured to rotate about a rotor axis (56), wherein the rotor axis is coaxial with the grinder axis

101. Centrifugal coffee brewing device according to the preceding claim, wherein the drive assembly comprises a direct drive electromotor, the direct drive electromotor comprising multiple coils (55) which are positioned in a circular arrangement (56) on the stator, each coil having a main axis which is oriented radially, and wherein a plurality of magnets (57) are positioned in a circular arrangement (58) on the rotor.

102. Centrifugal coffee brewing device according to any of the two preceding claims, wherein at least a part of the coffee bean grinder is positioned at a same vertical level (59) as the drive assembly.
